(19) United States
(12) Patent Application Publication
(10) Pub. No.: US 2008/0113284 A1
(43) Pub. Date: May 15, 2008

(54) ELECTROPHOTOGRAPHIC IMAGE FORMING METHOD AND YELLOW TONER USED IN THE METHOD

(75) Inventors: Kenji HAYASHI, Tokyo (JP); Mikio KOUYAMA, Tokyo (JP); Hiroyuki YASUKAWA, Tokyo (JP); Hiroaki OBATA, Tokyo (JP); Natsuko KUSAKA, Tokyo (JP); Tatsuya FUJISAKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/930,942

(22) Filed: Oct. 31, 2007

(30) Foreign Application Priority Data
Nov. 14, 2006 (JP) 2006308049

(51) Int. Cl. G03G 13/06; G03G 9/09

(52) U.S. Cl. 430/45.5; 430/108.1; 430/111.4

(57) ABSTRACT

An electrostatic image forming method is described. The method includes forming latent images corresponding to yellow, magenta and cyan images on a photoreceptor, developing corresponding latent images by developers containing yellow, magenta and cyan toner to form yellow, magenta and cyan images and transferring the yellow, magenta and cyan images on a recording material, and the yellow toner and the magenta have specific reflectance characteristics described in the specification.

This application is based on Japanese Patent Application No. 2006-308049 filed on Nov. 14, 2006, in Japanese Patent Office, the entire content of which is hereby incorporated by reference.

### TECHNICAL FIELD

The present invention relates to an electrostatic image forming method and a yellow toner employed for the electrophotographic methods.

### BACKGROUND OF THE INVENTION

Color image formation employing electrophotographic methods has been applied not only to office use such as color printers or color copiers, but also to commercial printing fields which are called desk-top publishing (DTP) and on-demand publishing. In these commercial printing fields, preferably employed are those such as pre-press machines which are employed in the preparatory stages to prepare plates for mass-printing, or machines which perform quick printing of a small lot such as several thousand prints to several ten thousand prints.

In commercial printing of color images, since output images themselves such as catalogues or pamphlets bear merchantability, accurate color reproduction is commercially demanded. Further, human eyes particularly result in high discriminating capability for “red” tints which thus cause impression of uplifting feeling of life. Based on the above reasons, many enterprises employ subtle “red” in their logos. Due to such a background, in the commercial printing of color images, with regard to “red”, high chroma and excellent color reproduction have been demanded.

Many color image forming apparatuses are constituted in such a way that all colors are reproduced employing three toners, namely yellow, magenta, and cyan. Various colors are formed via superimposing yellow, magenta, and cyan primary colors, while “red”, which is the secondary color via yellow and magenta, has not resulted in desired color reproduction and chroma.

In order to overcome the above drawbacks, following Patent Documents 1-3 have been proposed. However, at present, with regard to “red”, it is not possible to realize the desired color reproduction and chroma.

(Patent Document 1) Japanese Patent Publication. Open to Public Inspection (hereinafter referred to as JP-A) No. 2000-199982

(Patent Document 2) JP-A No. 2001-312102

(Patent Document 3) JP-A No. 2006-78926

### SUMMARY OF THE INVENTION

In view of the foregoing, the present invention was achieved. An object of the present invention is to provide a yellow toner which results in high chroma and excellent color reproduction with red which is a secondary color prepared by a combination with a general magenta toner and which is capable of resulting in color formation over an extremely wide color gamut.

An image forming method according to this invention comprises steps of,

forming latent images corresponding to yellow, magenta and cyan images on a photoreceptor or photoreceptors,

developing corresponding latent images by developers containing yellow, magenta and cyan toner to form yellow, magenta and cyan images and

transferring the yellow, magenta and cyan images on a recording material,

wherein the yellow toner and the magenta has reflectance characteristics of

2≦A₄₁₅+A₄₆₀≦24,

20≦A₅₁₀−A₄₉₀≦40,

4≦A₅₅₀−A₅₃₀≦16, and

70≦A₅₅₀,

and the magenta has reflectance characteristics of

30≦B₄₅₀−B₅₂₀≦85,

1≦B₅₃₀+B₅₇₀≦25,

2≦B₆₇₀−B₆₀₀≦50, and

80≦B₆₇₀,

wherein A₄₁₅, A₄₆₀, A₄₉₀, A₅₁₀, A₅₃₀, and A₅₅₀, each are reflectance in percent at a wavelength of 415 nm, 460 nm, 490 nm, 510 nm, 530 nm, and 550 nm in a reflectance spectrum of an image formed by the yellow toner, respectively, and

B₄₅₀, B₅₂₀, B₅₃₀, B₅₇₀, B₆₀₀, and B₆₇₀ a each are reflectance in percent at a wavelength of 450 nm, 520 nm, 530 nm, 570 nm, 600 nm, and 670 nm of an image formed by the magenta toner, respectively.

The yellow toner used in this invention is preferably composed of yellow toner particles which contain at least a binder resin and a yellow colorant and the difference ΔA between reflectance A₅₁₀ at a wavelength of 510 nm and reflectance A₄₉₀ at a wavelength of 490 nm in the reflectance spectrum is 20-40%, and is preferably 25-35%. Conventionally, the spectrum of the yellow toner reflectance difference ΔA has been about 45-50% generally.

Further, in the yellow toner with regard to the above reflectance spectrum, reflectance A₄₁₅ at a wavelength of 415 nm is preferably of 7-12%, reflectance A₅₇₀ at a wavelength of 570 nm is preferably of 75-85%, while reflectance A₇₀₀ at a wavelength of 700 nm is preferably in the range of 85-95%.

The yellow toner of the present invention is composed of yellow toner particles containing at least a binder resin and a yellow colorant, and is characterized in that the softening point temperature is in the range of 75-112° C., and difference ΔA between reflectance A₅₁₀ at a wavelength of 510 nm and reflectance A₄₉₀ at a wavelength of 490 nm in the reflectance spectrum is in the range of 20-40%.

In the yellow toner of the present invention, with regard to the above reflectance spectrum, reflectance A₄₁₅ at a wavelength of 415 nm is preferably in the range of 7-12%, reflectance A₅₇₀ at a wavelength of 570 nm is preferably in the range of 75-85%, while reflectance A₇₀₀ at a wavelength of 700 nm is preferably in the range of 85-95%.

It is preferable that colorant contains a pigment selected from the group consisting of Pigment Yellow 3, Pigment Yellow 34, Pigment Yellow 35, Pigment Yellow 65, Pigment Yellow 74, Pigment Yellow 98, and Pigment Yellow 111.

Further, it is preferable that the above yellow colorant contains, at a respective weight ratio of 65:35-95:5, colorants selected from at least following Groups Y1 and Y2.

(Group Y1): Pigment Yellow 3, Pigment Yellow 34, Pigment Yellow 35, Pigment Yellow 65, Pigment Yellow 74, Pigment Yellow 98, and Pigment Yellow 111,

(Group Y2): Pigment Yellow 36, Pigment Yellow 83, Pigment Yellow 110, Pigment Yellow 139, Pigment Yellow 181, Pigment Yellow 153, and Pigment Red 9.

More preferable example of the colorant above are listed as;
(Group Y1): Pigment Yellow 65, Pigment Yellow 74, Pigment Yellow 98, and Pigment Yellow 111.
(Group Y2): Pigment Yellow 83, Pigment Yellow 139, Pigment Yellow 181, and Pigment Yellow 153.

The yellow toner of the present invention exhibits the specified softening point temperature and specified state reflectance spectra, whereby it enables formation of red with high chroma and brightness, which is the secondary color obtained by a combination of general magenta toners, and also results in excellent color reproduction. Further, in the formation of “cardinal red”, it results in perception of high quality and enables formation of the wide color range from orange to “Bordeaux”.

### DETAILED DESCRIPTION OF THE INVENTION

The present invention will now be practically described.

An image forming method according to this invention comprises steps of,

forming latent images corresponding to yellow, magenta and cyan images on a photoreceptor,

developing corresponding latent images by developers containing yellow, magenta and cyan toner to form yellow, magenta and cyan images and

transferring the yellow, magenta and cyan images on a recording material,

wherein the yellow toner has reflectance characteristics of

2≦A₄₁₅+A₄₆₀≦24,

20≦A₅₁₀−A₄₉₀≦40,

4≦A₅₅₀−A₅₃₀≦16,

70≦A₅₅₀,

wherein the magenta toner has reflectance characteristics of

30≦B₄₅₀−B₅₂₀≦85,

1≦B₅₃₀+B₅₇₀≦25,

2≦B₆₇₀−B₆₀₀≦50, and

80≦B₆₇₀,

wherein A₄₁₅, A₄₅₀, A₄₉₀, A₅₁₀, A₅₃₀, and A₅₅₀, are reflectance spectrum in percent of an image formed by the yellow toner at a wavelength of 415 nm, 460 nm, 490 nm, 510 nm, 530 nm, and 550 nm, respectively, and

B₄₅₀, B₅₂₀, B₅₃₀, B₅₇₀, B₆₀₀, and B₆₇₀ are reflectance spectrum in percent of an image formed by the magenta toner at a wavelength of 450 nm, 520 nm, 530 nm, 570 nm, 600 nm, and 670 nm, respectively.

The yellow toner is preferably composed of yellow toner particles which contain at least a binder resin and a yellow colorant and the difference ΔA between reflectance A₅₁₀ at a wavelength of 510 nm and reflectance A₄₉₀ at a wavelength of 490 nm in the reflectance spectrum is in the range of 20-40%, and is preferably 25-35% when palletized. Further, in the yellow toner of the present invention, with regard to the above reflectance spectrum, reflectance A₄₁₅ at a wavelength of 415 nm is preferably of 7-12%, reflectance A₅₇₀ at a wavelength of 570 nm is preferably of 75-85%, while reflectance A₇₀₀ at a wavelength of 700 nm is preferably in the range of 85-95%.

With regard to reflectance spectra of the yellow toner by controlling difference ΔA between reflectance A₅₁₀ at a wavelength of 510 nm and reflectance A₄₉₀ at a wavelength of 490 nm within the range of 20-40%, it is possible to assuredly form a red of high chroma and excellent color reproduction, which is the secondary color formed via combination of the above yellow toner with magenta toners.

Further, in the above reflectance spectrum, by controlling reflectance A₄₁₅ at a wavelength of 415 nm within the range of 7-12%, reflectance A₅₇₀ at a wavelength of 570 nm within the range of 75-85%, and reflectance A₇₀₀ at a wavelength of 700 nm within the range of 85-95%, it is possible to more assuredly realize the above effects.

Further, the reflection spectrum of the toner is determined as follows. A spectrophotometer “GRETAG MACBETH SPECTROLINO” (produced by Macbeth Co.) is employed and determination conditions are such that light source D65 is employed as a light source, one at a reflection determination aperture of 4 mmφ is employed, an interval in the determination wavelength range of 380-730 nm is 10 nm, the viewing angle (observer) is set at 2°, and a white tile is employed to adjust the base line.

Further, it is preferable that hue angle h is satisfied in the relationship of 88°≦h≦103° in the yellow toner when the yellow toner is expressed in the L*a*b* color system in which L* represents lightness, a* represents hue in the red-green direction and b* represents hue in the yellow-blue direction.

“L*a*b* color system”, as described herein, is a means which is advantageously employed to represent color as numeric values. L* is the coordinate in the z axis direction and expresses lightness, while a* and b* are coordinates of the x and y axes, respectively, and their combination represents hue and chroma. Meanwhile, lightness, as described herein, refers to relative brightness of the color, while hue refers to color shade such as red, yellow, green, blue, or violet.

Further, “hue angle”, as described herein, refers to the following. For example, when lightness results in a certain value, on an x axis-y axis plane representing the relationship between hue and chroma, the hue angle is the angle of the half-line passing through a certain coordinate point (a, b) and origin O to the straight line extending to the + direction (red direction) of the x axis in the half clockwise direction from the + direction (red direction) of the x axis, and is calculated based on following Formula (1). Meanwhile, in the x axis-y axis plane, the − direction of the x axis, represented by a*, is the green direction, the+(plus) direction of the y axis, represented by b*, is the yellow direction, while the − (minus) direction of the above y axis is the blue direction.

Hue angle h=tan⁻¹(b*/a*) Formula (1):

L*, a*, and b* employed to calculate hue angle h are determined as follows. In practice, spectrophotometer “GRETAG MACBETH SPECTROLINO” (produced by Gretag Macbeth Co.) is employed and determination conditions are such that light source D6S is employed as a light source, one at a reflection determination aperture of 4 mmφ is employed, the interval in the determination wavelength range of 380-730 nm is 10 nm, the viewing angle (observer) is set at 2°, and an exclusive use white tile is employed to adjust the base line.

### <Chroma>

Further, when the above palletized yellow toner is represented employing the above L*a*b* color representation system, chroma C* is preferably at least 65, and is more preferably at least 70.

By controlling chrome C* within the above range, it is possible to prepare visible color images resulting in an extremely wide color gamut via superposition of other color toner images in which lightness is in the medium to high range. On the other hand, when chroma C* is less than 65, visible color images prepared via superposition of other color toner images result in color contamination, whereby it is not possible to prepare images of high sharpness Chroma C*, as described herein, refers to the distance from origin 0 of the above coordinate points (a and b), and is calculated based on following Formula (2).

Chroma C*=[(a*)²+(b*)²]^{1/2} Formula (2):

L*, a*, and b* employed to calculate chroma C* are determined as follows. In practice, spectrophotometer “GRETAG MACBETH SPECTROLINO” (produced by Gretag Macbeth Co.) is employed and determination conditions are such that light source D65 is employed as a light source, one at a reflection determination aperture of 4 mmφ is employed, the interval in the determination wavelength range of 380 730 nm is 10 nm, the viewing angle (observer) is set at 2°, and an exclusive use white tile is employed to adjust the base line.

### <Softening Point Temperature of Toner>

The softening point temperature of the toner of the present invention is 75-112° C., and is preferably 80-100° C.

By controlling the softening point temperature of the toner within the above range, an appropriate fusion state of the toner is maintained during the fixing process, whereby excellent color reproduction of secondary colors is realized.

“Appropriate fusion state of the yellow toner”, as described herein, refers to the state in which when a color image is formed by superimposing a toner image of a yellow toner with toner images of the other color toners, yellow-pigments in the toner image formed via the above yellow toner and magenta dyes incorporated in the toner image of, for example, a magenta toner are subjected to color superposition on a recording material and fixed, yellow pigments and magenta dyes form the color while uniformly dispersed and yellow pigments do not ooze out of the region of the exterior of the above color image region in a state of elimination of the interface of the layers formed employing both binder resins.

The yellow toner used in the present invention enables formation of color images while employed together with a magenta toner, a cyan toner, and a black toner. It is preferable that the above magenta toner, cyan toner and black toner are designed so that their softening point temperature and particle diameter become identical to that of the yellow toner.

“Softening point temperature of the yellow toner”, as described herein, refers to that which is determined as follows. Namely, initially, under an ambience of 20° C. and 50% relative humidity, 1.1 g of a yellow toner is placed in a Petri dish, flattened out, and allowed to stand for at least 12 hours. Thereafter, a 1 cm diameter cylindrical molded sample is prepared via application of a pressure of 3,820 kg/cm², employing molding machine “SSP-10A” (produced by Shimadzu Corp.). Subsequently, under an ambience of 24° C. and 50% relative humidity, by employing flow tester “CFT-500D” (produced by Shimadzu Corp.), the resulting sample is extruded from a cylindrical die hole (1 mm diameter×1 mm) employing a 1 cm diameter piston after pre-heating under conditions of an applied load of 196 N (20 kgf), an initial temperature of 60° C., and a temperature raising rate of 6° C./minute, and offset method temperature T_{offset} which is determined based on the fusion temperature determination method of the temperature raising method, which is set at an offset value of 5 mm, is designated as the softening point temperature of the yellow toner.

When the above binder resins are vinyl based copolymers, it is possible to regulate the softening point temperature of binder resins constituting yellow toner particles by controlling the copolymerization ratio of polymerizable monomers and the molecular weight regulated by the degree of polymerization For example, in a copolymer prepared employing styrene and butyl methacrylate, by increasing the composition ratio of styrene, it is possible to prepare a copolymer exhibiting a higher softening point temperature. Further, when the binder resins are polyester resins, it is possible to control the softening point temperature via the appropriate selection of the type of polymerizable monomers and the copolymerization ratio of copolymerizable monomers.

### <Diameter of Yellow Toner Particles>

Further, the diameter of yellow toner particles constituting the above yellow toner is 3.0-10.0 μm in terms of volume based median diameter, and is preferably 3.5-8.0 μm. When yellow toner particles are formed via a polymerization method, it is possible to control the above particle diameter via the concentration and added amount of aggregating agents, the aggregation period, and the composition of the polymer itself in the above production method of yellow toner.

By controlling the diameter of the yellow toner particles within the above range, it is possible to retard tone variation, irrespective of the toner adhesion amount, whereby it is possible to realize excellent color reproduction. On the other hand, when the average diameter of yellow toner particles is less than 3.0 μm in terms of volume based median diameter, due to tendency of light scattering, problems may occur in which tone between the halftone image which is formed in a state of a relatively small toner adhesion amount and a solid image which is formed in a state of relatively large toner adhesion amount differs, whereby specifically, halftone images formed by employing only the yellow toner result in a bluish tone.

The volume based median diameter of the yellow toner is determined and calculated employing a measuring device in which a data processing computer system (produced by Beckmann-Coulter Co.) is connected to “COULTER MULTISIZER TA-III”. In practice, 0.02 g of a yellow toner is added to 20 ml of a surface active agent solution (a surface active agent solution which is prepared by diluting a neutral detergent containing surface active agent components with purified water by a factor of 10 for the purpose of dispersing the yellow toner). After sufficient blending, ultrasonic dispersion is carried out over one minute, whereby a yellow toner dispersion is prepared. The resulting yellow toner dispersion is injected, employing a pipette, into a beaker on the sample stand, in which electrolyte “ISOTON II” (produced by Beckmann-Coulter Co.) is placed so that the displayed concentration of the measuring device, reaches 10%. By employing the above concentration, it is possible to obtain reproducible measured values. The above measuring device is set at a measuring particle account number of 25,000 and an aperture diameter of 50 μm. The measuring range of 1-30 μm is divided into 256, and the frequency values are calculated. The particle diameter of the 50% volume integral ratio from the large value is designated as the volume based radian diameter.

### <Average Degree of Circularity of Yellow Toner Particles>

With regard to each of the yellow toner particles constituting the above yellow toner, in view of enhancement of the transfer ratio, the average value of the degree of circularity (hereinafter referred to as “average degree of circularity”) represented by following Formula (3) is preferably 0.930-1.000, and is more preferably 0.950-0.995.

Average degree of circularity=peripheral length of circle obtained from circle equivalent diameter/peripheral length of particle projection image Formula (3)

It is preferable that each of the yellow toner particles, which constitute the yellow toner of the present invention, exhibits a core-shell structure which includes a core particle composed of binder resins and yellow colorants, and a shell layer composed of the shell layer forming resins (hereinafter also referred to as “shell resins”) containing substantially no dyes, which cover the circumferential surface of the core. In this case, the type of shell resins differ from that of binder resins constituting the core particles (hereinafter also referred to as “core binder resins”). BY constituting the yellow toner particles employing the core-shell structure, the above yellow toner particles result in high production stability and storage stability.

Yellow toner particles in the above core-shell structure may be those in which the shell layer completely or partly covers the core particle. Further, usable are structures in which some part of the shell resins, constituting the shell layer forms a domain in the core particle. Further, the shell layer may be a multi-layered structure of at least two layers composed of resins which differ in composition.

### <Production Method of Yellow Toner>

Listed as a method to produce the yellow toner of the present invention may be a kneading-pulverizing method, a suspension polymerization method, an emulsion polymerization method, an emulsion polymerization aggregation method, a mini-emulsion polymerization aggregation method, and an encapsulation method, as well as the known methods. As a method to produce yellow toner, by considering necessity of realizing the yellow toner composed of minute particles of a decreased diameter to achieve high image quality, it is preferable to employ the emulsion polymerization aggregation method in view of production cost and production stability.

The emulsion polymerization aggregation method is a method to produce yellow toner particles as follows. A dispersion of minute particles composed of binder resins produced by an emulsion polymerization method (hereinafter referred to as “minute binder resin particles”) is blended with a dispersion of yellow toner particle constituting components such as other minute colorant particles, and aggregation is slowly carried out while balancing the repulsive forces of minute particle surfaces due to pH control and aggregating forces due to the addition of aggregating agents composed of electrolytes, and coalescence is carried out while controlling the average particle diameter and the particle size distribution and simultaneously controlling the shape via fusion among minute particles via heating and stirring.

When the emulsion polymerization aggregation method is employed as a method to produce a yellow toner, the resulting minute binder resin particles may be structured of at least two layers composed of binder resins differing in composition. In such a case, it is possible to employ a method in which polymerization initiators and polymerizable monomers are added to a first resin particle dispersion prepared by an emulsion polymerization process (being a first stage polymerization) based on the conventional methods, and the resulting system is subjected to a polymerization process (being a second stage polymerization).

Further, in the production method of the yellow toner particles of the core-shell structure, as detailed later, initially, core particles are prepared via coalescence, aggregation, and fusion of minute core binder resin particles with minute colorant particles. Subsequently, it is possible to form a shell layer which covers the core particles in such a manner that minute shell resin particles, employed to form the shell layer, are added to the core particle dispersion, and the above minute shell resin particles are aggregated and fused onto the surface of the above core particles.

It is possible to regulate the shape of core particles constituting yellow toner particle of the core-shell structure via controlling, for example, the heating temperature of the aggregation-fusion process, and the heating temperature and duration during the first ripening process. Specifically, by controlling the heating duration during the first ripening process, it is possible to assuredly regulate the degree of circularity of coalesced particles.

Further, in the above core particles, the salting-out/fusing method which achieves salting-out/fusion, described below, is preferably applied to minute core binder resin particles, which are formed in such a manner that core binder resin forming polymerizable monomers, employed to constitute the above core particles, are mechanically dispersed into an aqueous medium to form minute particles, followed by a polymerizable monomer polymerization process, employing the mini-emulsion polymerization method, and minute colorant particles.

### (Yellow Colorants)

Yellow colorants used in the yellow toner of the present invention comprises a pigment selected from a group consisting Pigment Yellow 3, Pigment Yellow 34, Pigment Yellow 35, Pigment Yellow 65, Pigment Yellow 74, Pigment Yellow 98, and Pigment Yellow 111.

The colorants are preferably a combination of a pigment selected from the Group Y1 and a pigment selected from the Group Y2.

The yellow colorants are preferably mixtures of yellow pigments selected from following Group Y1 and Group Y2, and the mixing ratio is respectively in the range of 65:35-95:5 in terms of weight ratio.

The total content of yellow colorants belonging to Group Yl pigments and Group Y2 pigments in the yellow toner particles is in the range of 2-12 parts by weight with respect to 100 parts by weight of the yellow toner particles, and is preferably in the range of 4-10 parts by weight.

(Group Y1): Pigment Yellow 3, Pigment Yellow 34, Pigment Yellow 35, Pigment Yellow 65, Pigment Yellow 74, Pigment Yellow 98, and Pigment Yellow 111,

(Group Y2): Pigment Yellow 36, Pigment Yellow 83, Pigment Yellow 110, Pigment Yellow 139, Pigment Yellow 181, Pigment Yellow 153, and Pigment Red 9.

The pigments of Group Y11 and Group Y21 are preferable examples of the Group Y1 and Y2, respectively.

(Group Y11) Pigment Yellow 65, Pigment Yellow 74, Pigment Yellow 98, and Pigment Yellow 111

(Group Y2) Pigment Yellow 83, Pigment Yellow 139, Pigment Yellow 181, and Pigment Yellow 153

The above mixtures of yellow pigments, as listed above, are preferable specific examples which result in reflection spectra in the above specified state, but are not limited thereto.

It is possible to employ yellow colorants which have been subjected to surface modification. Employed as the surface modifying agents may be those conventionally known, but specifically employed are silane coupling agents, titanium coupling agents, aluminum coupling agents, and rosin.

A specific surface modifying method follows. Yellow colorants are dispersed in solvents and surface modifying agents are added to the resulting dispersion. The resulting system is then heated to undergo reaction. After the reaction, the yellow colorants are collected via filtration, and washing and filtration are repeated employing the same solvents, followed by drying, whereby yellow colorants treated with the surface modifying agents are produced.

A magenta colorant employed with the yellow colorant in combination is preferably an oil soluble dye or a chelate dye. A preferable reflective spectrum of magenta image can be obtained by employing a plurality of oil soluble magenta dyes or magenta pigment. Combination of magenta colorants themselves or a combination of a magenta colorant with a small amount of a cyan or yellow colorant may be employed. Oil soluble dyes are dyes which are generally provided with no water-soluble groups such as carboxylic acid and sulfonic acid and are soluble in an organic solvent but insoluble in water, however, include dyes exhibiting an oil-soluble property by salt formation of a water-soluble dye with a long chain base. For example, there are known salt-forming dyes of acid dyes, direct dyes and active dyes with long chain amines.

Specifically, an oil-soluble dye exhibiting a solubility in toluene of not less than 0.01 g/100 ml, that is, at least 0.01 g per 100 ml of toluene is preferred in the invention. The solubility of a dye is determined in such a manner that the dye is added to 100 ml of toluene at a temperature (25° C.), stirred and filtered after being allowed to stand for 24 hr. Toluene is distilled off from the solution to determine the weight of the dye contained in the solution. Solubility in water of the dye is determined similarly.

Specific examples of dyes are as follows: magenta dyes include C.I. Solvent Red 3 (0.7), the said 14 (0.03), the said 17 (1.0), the said 18 (0.8), the said 22 (3.0), the said 23 (1.4), the said 51 (1.4), the said 53 (0.1), the said 87 (0.2), the said 127 (0.3), the said 128 (1.2), the said 131 (0.2), the said 145 (0.2), the said 146 (1.1), the said 149 (0.19), the said 150 (0.07), the said 151 (0.2), the said 152 (0.89), the said 153 (0.8), the said 154 (0.2), the said 155 (0.05), the said 156 (0.5), the said 157 (0.6), the said 158 (0.9), the said 176 (0.05) and the said 179 (0.37), and C.I. Solvent Orange 63 (0.02), the said 68 (0.70), the said 71 (0.11), the said 72 (4.9) and the said 78 (0.33). Mixture thereof may be employed.

In the foregoing, numerals in parentheses indicate solubility in toluene. These dyes exhibit solubility in water of not more than 1% by weight, that is, not more than 1 g per 100 g of water.

### (Chelate Dye)

A chelate dye refers to a compound in which dyes coordinate to a metal ion at two- or more dentate coordination, provided that a ligand other than dyes may be coordinated. In the invention, the ligand refers to an atom or atomic group capable of coordinating to a metal ion, which may be electrically charged or not.

Metal chelate dyes usable in the invention are compounds represented by the following formula (D):

(Dye)ₙM(A)ₘ (D)

wherein M represents a metal ion, “Dye” represents a dye capable of coordinating to the metal ion, A represents a ligand other than the dye, n is an integer of 1 to 3, and m is an integer of 0 and 1 to 3, provided that when m is 0, n is 2 or 3 and plural “Dye”s may be the same or different.

Metal ions represented by M include ions of metals of Group I to VIII of the periodical table, for example, ions of Al, Co, Cr, Cu, Fe, Mn, Mo, Ni, Sn, Ti, Pt, Pd, Zr and Zn. Of these metal ions, ions of Ni, Cu, Cr, Co, Zn and Fe are preferred in terms of color and various types of durability. Preferred metal chelate dyes are disclosed in JP-A Nos. 9-277693, 10-20559 and 10-30061.

The above mentioned dyes may be employed in single or plural in combination as required. Content of the dye is preferably 0.1-10% by weight and more preferably 0.5-5% by weight based on the toner particles.

Compounds of formula (D) are exemplified. Compounds L1-L269 represented by formula (Dye) and compounds 1-71 represented by formula M(A)ₘ are shown.

Equal mol of compound (Dye) (around 0.5-2 parts by weight) and compound and M(A)ₘ (around 2-4 parts by weight) are dissolved in 100 parts by weight of ethylacetate and mixed, for reacting these compounds. All of (Dye) and (A)ₘ are coordinated to M, and chelate reaction is completed. The obtained colorant is employed after removing solvent.

Preferable examples of a compound of formula (D) is triazole compound.

Preferable examples of (Dye) are 1-1 to 1-20.

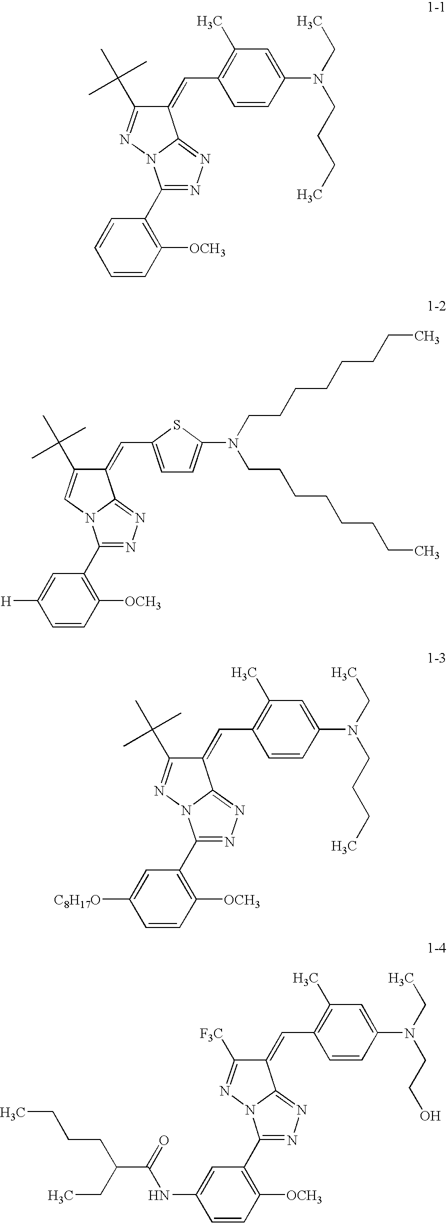

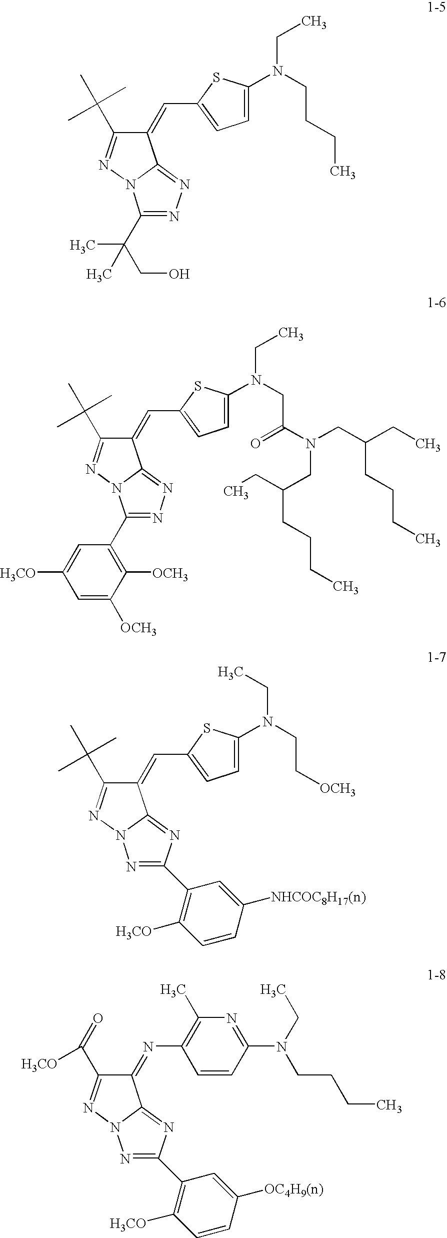

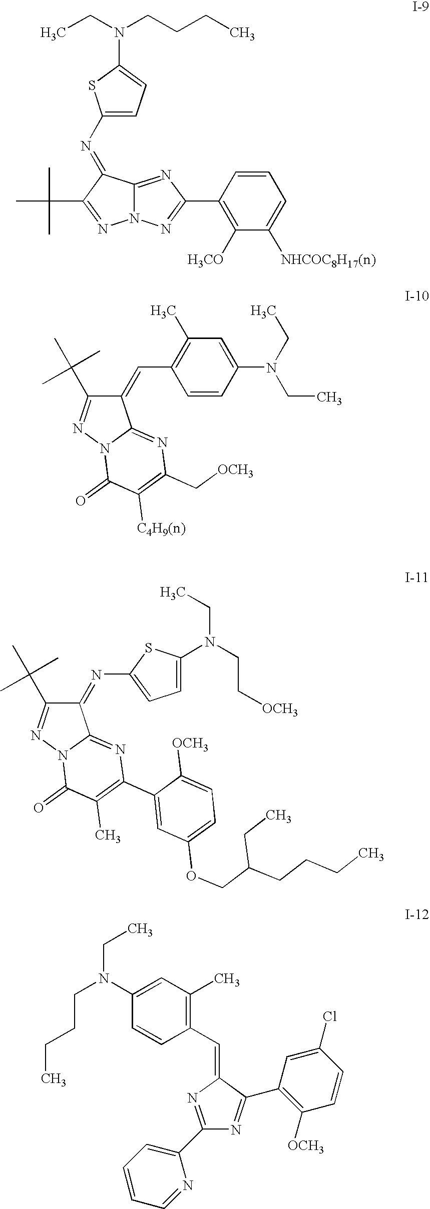

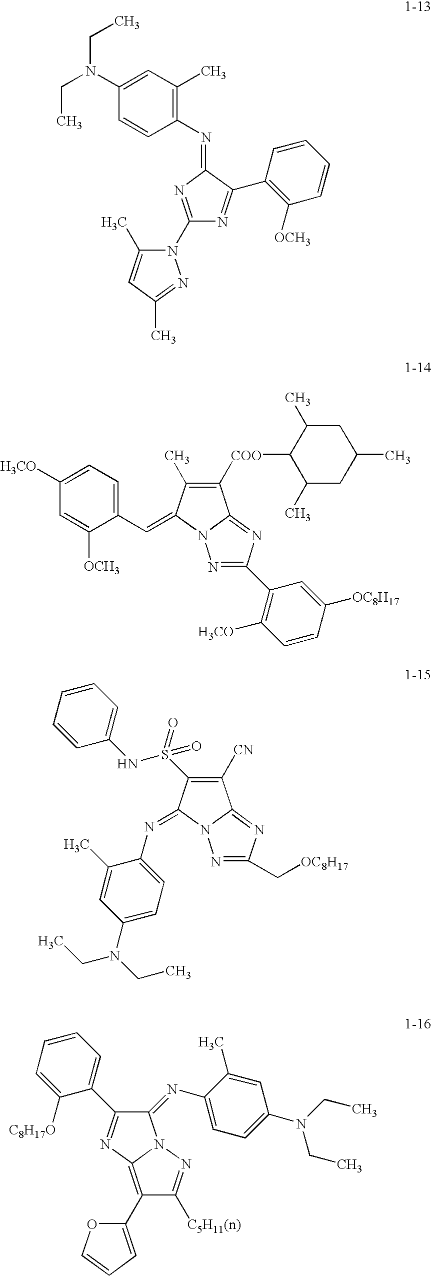

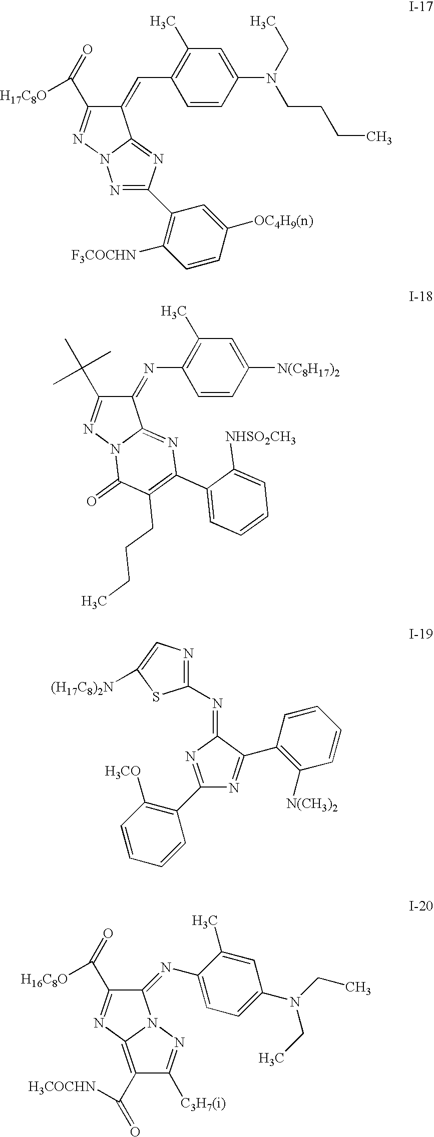

### Preferable examples of a compound of formula M(A)ₘ includes exemplified compounds M-1 to M-13.

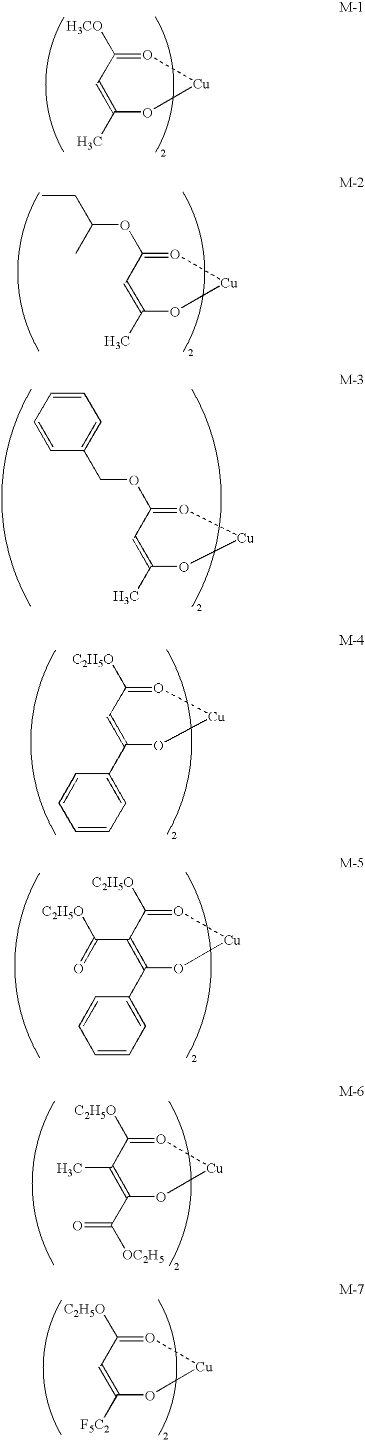

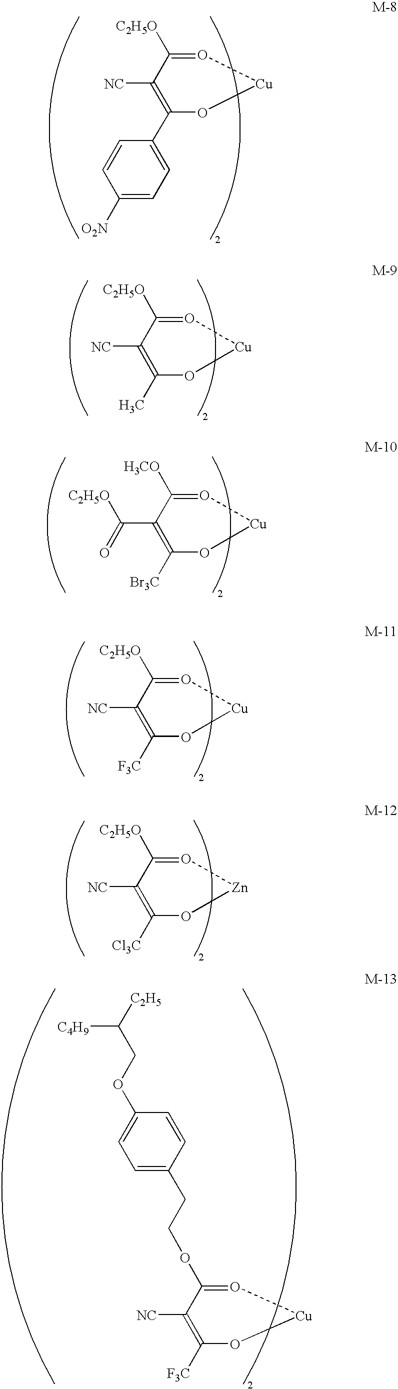

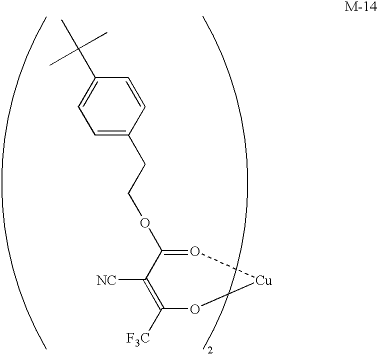

Preferable examples of the metal chelate dyes are described.

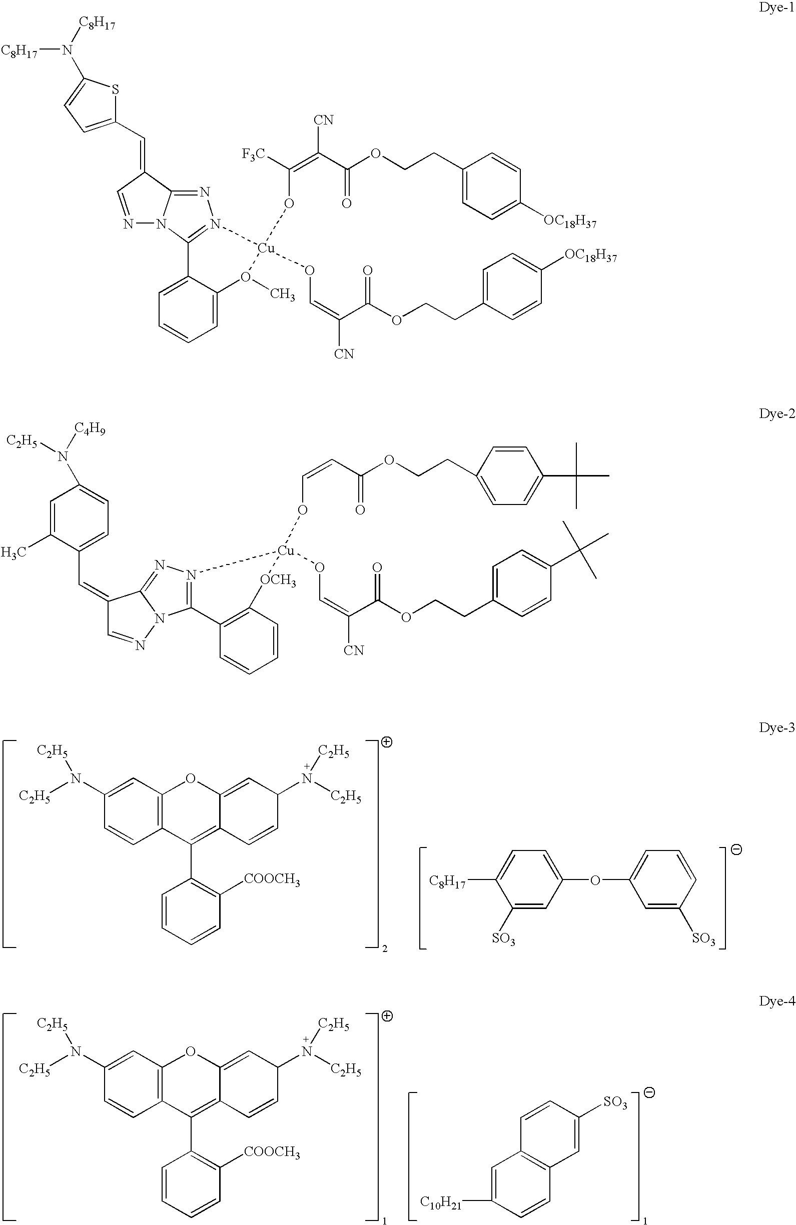

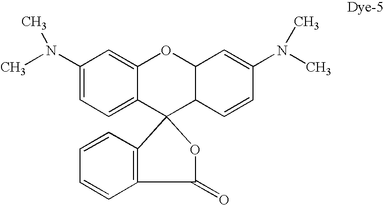

### (Binder Resins)

When yellow toner particles constituting the yellow toner of the present invention are produced via, for example, a pulverization method and a dissolution suspension method, preferable resins to constitute the yellow toner include vinyl based resins such as styrene based resins, (meth)acryl based resins, styrene-(meth)acryl based resins, or olefin based resins, as well as various prior art resins such as polyester based resins, polyamide based resins, polycarbonate resins, polyether resins, polyvinyl acetate based resins, polysulfone, epoxy resins, polyurethane resins, or urea resins. Specifically, in order to enhance transparency and color reproduction of superposed images, preferably listed are styrene based resins, acryl based resins, and polyester resins which exhibit high transparency and melt characteristics of sharp melting properties at low viscosity These resins may be employed individually or in combinations of at least two types.

Further, when yellow toner particles of the present invention are produced by, for example, a suspension polymerization method, a mini-emulsion polymerization aggregation method, or an emulsion polymerization aggregation method, listed as polymerizable monomers may, for example, be vinyl based monomers including styrene or styrene derivatives such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, or p-n-decylstyrene, p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, dimethylaminoethyl methacrylate, or dimethylaminoethyl methacrylate; acrylic acid ester derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, or phenyl acrylate; olefins such as ethylene, propylene, or isobutylene; vinyl fluorides such as vinyl fluoride or vinylidene fluoride; vinyl esters such as vinyl propionate, vinyl acetate, or vinyl benzoate; vinyl ethers such as vinyl methyl ether or vinyl methyl ether; vinyl ketones such as vinyl methyl ketone, vinyl ethyl ketone, or vinyl hexyl ketone; N-vinyl compounds such as N-vinylcarbazole, N-vinylindole, or N-vinylpyrrolidone; vinyl compounds such as vinylnaphthalene or vinylpyridine; and acrylic acid or methacrylic acid derivatives such as acrylonitrile, methacrylonitrile, or acrylamide. These vinyl based monomers may be employed individually or in combinations of at least two types.

Further, it is preferable that those monomers having an ionic dissociating group are employed as a polymerizable monomer in combination. Polymerizable monomers having an ionic dissociating group are those having a substituent such as a carboxyl group, a sulfonic acid group, or a phosphoric acid group, and specific examples include acrylic acid, methacrylic acid, maleic acid, itaconic acid, cinnamic acid, fumaric acid, monoalkyl maleate, monoalkyl itaconate, styrenesulfonic acid, allylsulfonic acid, 2-acrylamido-2-methylpropanesulfonic acid, and acid phosphoxyethyl methacrylate.

Further, it is also possible to produce binder resins of a crosslinking structure, employing polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, or neopentyl glycol diacrylate.

When yellow toner particles are of a core-shell structure, styrene-acryl based resins are preferable as each of core binder reins and shell resins.

When core binder resins are composed of copolymers, it is preferable that as polymerizable monomers to produce the above copolymers, included are those such as propyl acrylate, propyl methacrylate, butyl acrylate, butyl methacrylate, 2-ethylhexyl acrylate, or 2-3thylhexyl methacrylate, which enable a decrease in glass transition temperature (Tg) of the resulting copolymers.

The copolymerization ratio of the above polymerizable monomers is 8-80% by weight with respect to the total polymerizable monomers to form core binder resins, and is preferably 9-70% by weight.

Other than the specific examples listed above, these polymerizable monomers may be in the form of acid anhydride or a vinylcarboxylic acid metal salt.

Further, when shell resins are composed of copolymers, it is preferable that as polymerizable monomers to produce the above copolymers, incorporated are those such as styrene, methyl methacrylate, or methacrylic acid, which enable an increase in glass transition temperature (Tg) of the resulting copolymers.

The copolymerization ratio of such polymerizable monomers is 8-80% by weight with respect to the total polymerizable monomers to form shell resins, and is preferably 9-20% by weight.

Other than the specific example listed above, these copolymerizable monomers may be in the form of acid anhydride or a vinylcarboxylic acid metal salt.

The binder resins which constitute the yellow toner of the present invention, in cases in which the above yellow toner is in the core-shell structure, produced for example, by an emulsion polymerization method, an emulsion polymerization aggregation method, or a mini-emulsion polymerization aggregation method, each of the molecular weights of the binder resins, which form core particles and the shell layer which constitute the yellow toner particles, is preferably within the following range.

Namely, it is preferable that the binder resins constituting core particles exhibit a peak of the weight average molecular weight (Mw) in the range of 5,000-30,000, which is determined via gel permeation chromatography (GCP) of THF-soluble components, and the binder resins constituting the shell exhibit a peak of the weight average molecular weight (Mw) in the range of 10,000-80,000, which is determined via gel permeation chromatography (GCP) of THF-soluble components. Further, it is more preferable that the binder resins constituting core particles and the binder resins constituting the shell exhibit a peak of the weight average molecular weight (Mw) in the range of 15,000-28,000, and a peak of the weight average molecular weight (Mw) in the range of 10,000-50,000, respectively.

Further, the glass transition temperature (Tg) of binder resins constituting the core particles is 10-50 ° C., and is preferably 25-48° C., while the glass transition temperature (Tg) of the binder resins constituting the shell layer is 38-64° C., and is preferably 40-54° C.

On the other hand, for example, when the above yellow toner is not in a core-shell structure, the number average molecular weight (Mn) of the binder resin which constitutes the above yellow toner of the present invention is preferably 3,000-6,000, determined by gel permeation chromatography (GCP) of THF-soluble components, and is more preferably 3,500-5,500, and ratio Mw/Mn of weight average molecular weight (Mw) to number average molecular weight (Mn) is 2.0-6.0, and is preferably 2.5-5.5, while the glass transition temperature (Tg) is 50-70° C., and is preferably 55-70° C.

Molecular weight, via GCP, was determined as follows. Namely employed were “HLC-8220” (produced by TOSOH Corp.) and a column “TSK guard column+TSK gel Super HZM-M3 Ren” (produced by TOSOH Corp.). While maintaining the column temperature at 40° C., tetrahydrofuran (THF), as a carrier solvent, was allowed to flow at a flow rate of 0.2 ml/minute, and at room temperature, a measurement sample was dissolved in tetrahydrofuran to reach a concentration of 1 mg/ml under dissolving conditions of the use of an ultrasonic homogenizer and treatment for 5 minutes. Subsequently a treatment was carried out employing a 0.2 μm pore size membrane filter, whereby a sample was prepared. Further, 10 μL of the resulting sample was injected into the instrument together with the above carrier solvent, and detected employing a refractive index detector (being an IR detector), whereby the molecular weight was calculated, employing the calibration curve which determined the molecular weight distribution of the measured sample, employing standard monodispersed polystyrene particles. Employed as the standard polyethylene sample to prepare the calibration curve were those of a molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶, and a calibration curve was prepared via measurement of at least approximately 10 standard polystyrene samples. Further employed as the detector was a refractive index detector.

Further, the glass transition temperature (Tg) of binder resins was determined employing differential scanning calorimeter “DSC-7” (also produced by Perkin-Elmer), and thermal analyzer controller “TAC7/DX” (produced by Perkin-Elmer). In practice, 4.5 mg of a yellow toner was sealed in an aluminum pan “KIT No. 0219-0041” and was set into the sample holder. During measurement, a blank aluminum pan was employed as a reference. Under measurement conditions of 0-200° C., a temperature increasing rate of 10° C./minute, and a temperature decreasing rate of 10° C./minute, heating-cooling-heating temperature control was carried out. Data were recorded during the 2nd heating, and the intersection of the extension of the base line prior to the initial rise of the first endothermic peak with the tangent which showed the maximal inclination between the initial rising position of the first endothermic peak and the top of the peak was used as the glass transition temperature (Tg).

Further, the binder resins, related to the above yellow toner, are acceptable when the softening point temperature of the resulting yellow toner is in the above range.

The yellow toner of the present invention, such as one of a core-shell structure, is produced via the following specific processes: (1) a minute colorant particle dispersion preparation process which prepares a minute colorant particle dispersion in which yellow colorants are dispersed in minute particles; (2-1) a minute core binder resin particle polymerization process in which minute binder resin particles composed of binder resins containing, if desired, releasing agents and charge control agents is prepared, followed by preparation of dispersion of the minute binder resin particles; (2-2) a minute shell resin particle polymerization process in which minute resin particles are prepared followed by preparation of a dispersion of these particles; (3) an aggregation fusion process which forms coalesced particles employed as core particles via aggregating and fusing minute core binder resin particles and minute colorant particles in an aqueous medium; (4) a first ripening process which prepares core particles by controlling the shape via thermally ripening the coalesced particles; (5) a shell layer forming process in which particles in the core-shell structure are formed in such a manner that minute shell resin particles, employed to form a shell layer, are added to the core particle dispersion and the above minute shell resin particles are aggregated and fused onto the surface of the core particles; (6) a second ripening process which prepares yellow colored particles in the core shell structure by controlling the shape via thermally ripening the particles in the core-shell structure, employing heat energy; (7) a filtration washing process in which yellow colored particles are subjected to solid-liquid separation from the cooled yellow colored particle dispersion system (being an aqueous medium) and surface active agents are removed from the resulting yellow colored particles; and (8) a drying process which dries the yellow colored particles which have been washed. If desired, after the drying process, carried out may be (9) an external agent treating process which prepares yellow toner particles via adding external agents to the dried and treated yellow colored particles.

Each of the above production processes to prepare the toner of the present invention will now be described.

### (1) Minute Colorant Particle Dispersion Preparation Process

In this process, yellow pigments which are yellow colorants are added to an aqueous media and the resulting mixture is dispersed via a homogenizer, whereby a minute colorant particle dispersion is prepared in which the yellow colorants are dispersed into minute particles. Specifically, dispersion of the yellow colorants is carried out, as detailed below, in an aqueous medium in such a state that the concentration of surface active agents is regulated to be at least the critical micelle concentration (CMC). Homogenizers employed for dispersion are not particularly limited, but preferably listed are an ultrasonic homogenizer, a mechanical homogenizer, a pressurized homogenizer, such as a Manton-Gaulin or a pressure system homogenizer, a medium type homogenizer such as a sand grinder, a Getzmann mill, or a fine diamond mill.

The diameter of minute colorant particles in the above minute colorant particle dispersion is preferably 40-200 nm in terms of volume based median diameter.

### (2-1) Minute Core Binder Resin Particle Polymerization Process

In this process, polymerization is carried out so that a dispersion of minute binder resin particles is prepared, composed of core binder resins, if desired, containing releasing agents and charge control agents.

One of the appropriate examples of the polymerization in this process is as follows. A polymerizable monomer solution containing, if desired, releasing agents and charge control agents, is added to an aqueous medium containing surface active agents at a concentration of at most the critical micelle concentration (CMC). Subsequently, mechanical energy is applied to the resulting mixture to form droplets, followed by the addition of water-soluble polymerization initiators, whereby polymerization reaction is performed within the above droplet. In the meantime, oil-soluble polymerization initiators may be incorporated within the above droplet. In the above process, it is essential to carry out enforced emulsification (formation of droplets) via application of mechanical energy. Listed as such mechanical energy application means may be those such as a homomixer, an ultrasonic homogenizer, or a Manton-Gaulin homogenizer, which provide strong agitation or ultrasonic vibrational energy.

### (Surface Active Agents)

The above surface active agents are not particularly limited, and appropriate examples include ionic surface active agents such as sulfonic acid salts (sodium dodecylbenzenesulfonate, and sodium arylalkyl polyethersulfonate); sulfuric acid ester salts (sodium dodecylsulfate, sodium tetradecylsulfate, sodium pentadecylsulfate, and sodium octylsulfate); fatty acid salts (sodium oleate, sodium laureate, sodium caprate, sodium caprylate, sodium caproate, potassium stearate, and calcium oleate). Further employable are nonionic surface active agents such as polyethylene oxide, polypropylene oxide, and a combination of polypropylene oxide with polyethylene oxide, esters of polyethylene glycol with higher fatty acids, alkylphenol polyethylene oxide, esters of fatty acids with polyethylene glycol, esters of higher fatty acids with polypropylene oxide, or sorbitan esters. These surface active agents are usable in other processes such as a colorant dispersion preparation process.

### (Polymerization Initiators)

It is possible to list, as the above water-soluble polymerization initiators, persulfates such as potassium persulfate or ammonium persulfate, azobisaminodipropane acetate, azobiscyanovaleric acid and its salts, and hydrogen peroxide.

Further listed as oil-soluble radical polymerization initiators may be azo based or diazo based polymerization initiators such as 2,2′-azobis-(2,4-dimethylvaleronitrile), 2,2′-azobisbutyronitrile, 1,1′-azobis(cyclohexane-1-carbonitrile), 2,2′-azobis-4-methoxy-2,4-dimethylvaleronitrile, or azobisisobutyronitrile, as well as peroxide based polymerization initiators and polymer initiators having a peroxide in the side chain such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, or tris-(t-butylperoxy)triazine.

### (Chain Transfer Agents)

In this polymerization process, to regulate the molecular weight of the resulting core binder resins, generally employed chain transfer agents are usable.

Chain transfer agents are not particularly limited and usable examples include mercaptans such as n-octylmercaptan, n-decylmercaptan, or tert-dodecylmercaptan, n-octyl-3-mercaptopropionic acid ester, terpinolene, and α-methylstyrene dimers.

### (Releasing Agents)

Releasing agents, which contribute to retardation of offsetting phenomena, may be contained in yellow toner particles constituting of the yellow toner of the present invention. Releasing agents are not particularly limited, and examples include polyethylene wax, oxidation type polyethylene wax, polypropylene wax, oxidation type polypropylene wax, carnauba wax, sazol wax, rice wax, and candelilla wax.

The content ratio of the releasing agents in the yellow toner particles is generally 0.5-5 parts by weight, and is preferably 1-3 parts by weight with respect to 100 parts by weight of the binder resins. When the content ratio of the releasing agents is less than 0.5 part by weight with respect to 100 parts by weight of the binder resins, no sufficient offset minimizing effect is realized, while when it exceeds 5 parts by weight, transparency and color reproduction of the resulting yellow toner are degraded.

### (Charge Control Agents)

If desired, charge control agents may be contained into the toner particles constituting the yellow toner of the present invention. Employed as the charge control agents may be any of the various compounds known in the art.

In this process, produced may be those containing yellow colorants as minute core binder resin particles. It is possible to prepare minute core binder resin particles colored with yellow colorants by polymerizing polymerizable monomer compositions containing yellow colorants. When minute core binder resin particles which have been colored with the yellow colorants, without carrying out (1) a minute colorant particle dispersion preparation process, it is possible to prepare colored core particles by aggregate-fusing the above minute colored core binder resin particles in the (3) aggregation and fusion process described below.

### (2-2) Minute Shell Resin Particle Polymerization Process

In this process, in the same manner as the above (2-1), minute core binder resin particle polymerization process, a minute shell resin particle dispersion, composed of shell resins, is prepared via polymerization.

### (3) Aggregation Fusion Process

This process is which forms coalesced particles to be modified to core particles via aggregating and fusing minute core binder resin particles with minute colorant particles in an aqueous medium. Preferred as an aggregation fusion method in this process is a salting-out/fusion process, employing the minute colorant particles prepared via (1) minute colorant particle dispersion preparation process and the minute core binder resin particles prepared via (2-1) minute core binder resin particle polymerization process. Further, in the above aggregation fusion process, it is possible to aggregate and fuse minute releasing agent particles and internal additive particles such as a charge control agent together with minute core binder resin particles and minute colorant particles.

“Salting-out/fusion”, as described herein, refers to a process in which aggregation is carried out along with fusion, and when particles grow to the predetermined particle diameter, particle growth is terminated via the addition of aggregation termination agents, while if desired, heating is further continued to control the particle shape.

A salting-out/fusion method is as follows. Salting-out agents composed of alkaline metal salts, alkaline earth metal salts, and trivalent salts are added to an aqueous medium in which minute core binder resin particles and minute colorant particles are present so that the concentration exceeds the critical aggregation concentration. Subsequently, the resulting mixture is heated to at least the glass transition temperature of the above minute resin particles and also to at least melting peak temperature (° C.) of the minute core binder resin particles and minute colorant particles, whereby salting-out and fusion are simultaneously carried out. With regard to alkaline metal salts and alkaline earth metal salts as a salting-out agent, listed as alkaline metals are lithium, potassium, and sodium, while listed as alkaline earth metals are magnesium, calcium, strontium, and barium. Of these, preferably listed are potassium, sodium, magnesium, calcium, and barium.

When the aggregation fusion process is carried out, employing the salting-cut/fusion method, it is preferable to have the standby duration after the addition of salting-out agents as short as possible. The reasons for that are not fully understood. The aggregation state of particles varies depending on the standby duration after salting-out, whereby problems occur in which the particle size distribution becomes unstable and the surface characteristics of coalesced particles via fusion fluctuate. Further, it is essential that the temperature during the addition of salting-out agents is at most the glass transition temperature of minute core binder resin particles. The reasons for this are that when the temperature during the addition of salting-out agents is at least the glass transition temperature of minute core binder resin particles, salting-out/fusion of the minute binder resin particles proceeds quickly, while it is not possible to control the particle diameter, whereby problems such as formation of particles of a relatively large diameter occur. The range of this addition temperature may be acceptable when it is at most the glass transition temperature of the resins, and is generally 5-55° C., and is preferably 10-45° C.

Further, salting-out agents are added at equal to or less than the glass transition temperature of the minute core binder resin particles. Thereafter, the temperature is increased as soon as possible, to at least the glass transition temperature of the minute core binder resin particles and at least the melt peak temperature (° C.) of the minute core binder resin particles and the minute colorant particles. The duration up to this temperature increase is preferably less than one hour. Further, though it is necessary to quickly increase the temperature, the rate of temperature increase is preferably at least 0.25° C./minute. The upper limit is not clear. However, when the temperature is increased almost instantaneously, salting-out proceeds rapidly, whereby problems occur in which it is difficult to control the particle diameter. Thus at most 5° C./minute is preferred.

Via the above salting-out/fusion method, produced is a dispersion of coalesced particles (core particles) prepared via salting-out/fusion of minute core binder resin particles and any of the minute particles.

Further, “aqueous medium”, as described herein, refers to a medium composed of 50-100% by weight of water and 0-50% by weight of water-soluble organic solvents. it is possible to exemplify, as water-soluble organic solvents, methanol, ethanol, isopropanol, butanol, acetone, methyl ethyl ketone, and tetrahydrofuran. Of these, preferred are alcohol based organic solvents which do not dissolve the resulting resins.

### (4) First Ripening Process

In this process, coalesced particles are subjected to ripening via heat energy.

Further, by controlling heating temperature during the aggregation and fusion process and specifically controlling heating temperature and period during the ripening process, it is possible to control the resulting core particles so that the surface of the core particle, of a definite diameter and of a narrow distribution, is smooth and the shape is uniform. In practice, during the aggregation and fusion process, heating temperature is relatively low to retard progress of fusion among resin particles, whereby uniformity is enhanced, and during the first ripening process, heating temperature is relatively low and the ripening period is relatively long, whereby the surface of core particles is controlled to become uniform.

### (5) Shell Forming Process

During the shell forming process, a minute shell resin particle dispersion is added to a core particle dispersion, and minute shell resin particles are aggregated and fused onto the surface of the core particles, whereby the surface of the core particles is covered by the shell resins to form particles having the core-shell structure.

The above shell forming process is the preferable production process to realize both low temperature fixability and heat resistant retention properties. Further, when color images are to be formed, it is preferable to utilize the above shell forming process to enable the desired color reproduction of secondary colors.

Specifically, while maintaining the core particle dispersion at the heating temperature during the above aggregation and fusion process as well as during the first ripening process, the minute shell resin particles are added, and particles of the core-shell structure are formed in such a manner that while heated and stirred, the surface of core particles is gradually over several hours covered by the minute shell resin particles. The heating and stirring duration is preferably 1-7 hours, and is more preferably 3-5 hours.

### (6) Second Ripening Process

When the diameter of particles of the core-shell structure reaches the predetermined value by the shell formation, particle growth is terminated by the addition of termination agents such as sodium chloride. Thereafter, in order to fuse minute shell resin particles which are allowed to adhere to core particles, heating and stirring are continued over several hours, whereby the thickness of the layer formed by the minute shell resin particles, which cover the surface of the core particles, is regulated to 100-300 nm. As described above, the shell layer is formed by allowing the minute shell resin particles to adhere onto the surface of core particles, whereby rounded yellow-colored particles of uniform shape are formed.

In the production method of the yellow toner of the present invention, it is possible to control the shape of colored particles to be spherical by setting the period of the above second ripening process to be relatively long or setting the ripening temperature to be relatively high.

### (7) Filtration and Washing Process

During this process, initially, the above yellow-colored particle dispersion is cooled. It is preferable that cooling is carried at a cooling rate of 1-20° C./minute. Cooling methods are not particularly limited, and methods may exemplified in which cooling is carried out via introduction of a cooling medium from the exterior of the reaction vessel and cooling is carried out via direct charging of cooled water into the reaction system.

Subsequently, the above yellow-colored particles are subjected to solid/liquid separation from the yellow-colored dispersion which has been cooled to the predetermined temperature. Thereafter, washing is carried out in which adhered materials, such as surface active agents or salting-out agents, are removed from the toner cake (being an aggregated substance prepared by aggregating the yellow-colored particles in a wet state to be cake-like). The above filtration methods are not particularly limited and include a centrifugal separation method, a vacuum filtration method which is carried out employing a Buchner funnel and a filtration method which is carried out employing a filter press.

### (8) Drying Process

During this process, the washed yellow toner cake is dried and dried yellow-colored particles are prepared. Driers employed in this process include spray driers, vacuum-freeze driers, and reduced-pressure driers. It is preferable to employ a static tray drier, a portable type tray drier, a fluidized-bed drier, a rotary drier, or an agitation type drier. Moisture in the dried colored particles is preferably at most 5% by weight, and is more preferably at most 2% by weight. Meanwhiler when dried colored particles are aggregated via a weak mutual attraction force, the resulting aggregates may be crushed. It is possible to employ, as a crushing machine, mechanical crushing ones such as a jet mill, a Henschel mixer, a coffee mill, or a food processor.

### (9) External Addition Process

Yellow-colored particles, which will be converted to the yellow toner in the present invention, may be employed as the yellow toner particles of the present invention without any modification. However, to improve fluidity and charging properties and to enhance cleaning properties, they may be employed after addition of so-called external additives. The above external additives are not particularly limited, and various minute inorganic and organic particles, as well as aliphatic metal salts are usable.

It is preferable to employ, as the above minute inorganic particles, inorganic oxide particles such as silica, titania, or alumina, which may be subjected to hydrophobic treatment employing silane coupling agents or titanium coupling agents. Further employed as minute organic particles may be spherical ones, at a number average diameter of the primary particles, of about 10—about 2,000 nm. Employed as the above minute organic particles may be those composed of polystyrene, polymethyl methacrylate, or copolymers such as a styrene-methyl methacrylate copolymer.

The addition ratio of these external additives to the yellow toner is 0.1-5.0 by weight, and is preferably 0.5-4.0% by weight. Further, the external additives may be employed in combinations of various types.

### <Recording Materials>

Recording materials, on which images are formed, via the yellow toner of the present invention, are supports carrying yellow toner images. Specific examples include, but not are limited to, various types of paper such as plain paper from thin paper to heavy paper, quality paper, coated paper such as art paper or coated paper, commercial Japanese paper and post-card paper, OHP plastic film, or fabric.

### <Developers>

The yellow toner of the present invention may be employed as a non-magnetic single component developer, but may also be employed as a double component developer after being blended with carriers. When the yellow toner of the present invention is employed as a double component developer, magnetic particles are usable as a carrier, which are composed of the materials known in the art such as metals of iron, ferrite, or magnetite, as well as alloys of the above metals with aluminum or lead. Of these, ferrite particles are particularly preferred. Further employed as carriers may be coated carriers prepared by covering the surface of magnetic particles with resins, and binder type carriers prepared by dispersing minute magnetic powders into the binder resins.

Covering resins to constitute coated carriers are not particularly limited, and examples include olefin based resins, styrene based resins, styrene-acryl based resins, silicone based resins, and fluororesins. Further, resins to constitute resin dispersion type carriers are not particularly limited and those known in the art are usable, which include, for example, styrene-acryl based resins, polyester based resins, fluororesins, and phenol resins.

The volume based median diameter of carriers is preferably 20-100 μm, and is more preferably 20-60 μm. It is possible to determine the volume based median diameter of carriers employing a laser diffraction type particle size distribution meter “HELOS” (produced by Sympatec Co.) as a representative meter.

In view of spent resistance, listed as preferable carriers are coated carriers which employ, as a coating resins, silicone based resins, copolymer resins (graft resins) of organopolysiloxane with vinyl based monomers, or polyester resins. In view of durability, stability against environment, and spent resistance, preferably listed are carriers which are covered by the resins which are prepared by allowing copolymer resins (or graft resins) of organopolysiloxane with vinyl based monomers to react with isocyanate.

The above yellow toner exhibits the predetermined softening point temperature and the reflection spectra in the predetermined state, whereby red, which is the secondary color via combination of general magenta toners, results in high chroma, excellent color reproduction, and resulting “cardinal red” exhibits a high feeling of quality, and further, a wide color range from orange to Bordeaux is achievable.

### <Image Forming Method>

The color image is formed by yellow, magenta and cyan toners, and a black toner may be further employed. Each of the toner images may be formed on a single photoreceptor and then transferred onto an image recording material. Or each of the toner images may be formed on respective photoreceptors corresponding to the color toners, and then transferred onto an image recording material. The toner images may be transferred onto the recording sheet directly or transferred onto an intermediate transfer device and then transferred onto the image recording material.

### EXAMPLES

Specific examples of the present invention will now be described.

The volume based median diameter of the colorant particles dispersion was determined via “MICROTRAC UPA 150” (produced by Honeywell Co.) under the following measurement conditions.

### (Measurement Conditions)

Refractive index of sample: 1.59

Specific gravity of sample: 1.05 (in terms of spherical particle)

Refractive index of solvent: 1.33

Viscosity of solvent: 0.797 at 30° C., and 1.002 at 20° C.

Zero point adjustment was carried out via placing ion-exchanged water in the measurement cell.

### Preparation Example of Minute Yellow Colorant Dispersion 1

While stirring, 11.5 parts by weight of sodium n-dodecylsulfate were dissolved in 160 parts by weight of ion-exchanged water followed by the gradual addition of each of 22.5 parts by weight of C.I. Pigment Yellow 74 (species Y1) and 2.5 parts by weight of C.I. Pigment Yellow 139 (species Y2). Subsequently, the resulting mixture was dispersed employing “CLEARMIX W MOTION CLM-0.8” (produced by M Technique Co.), and Minute Yellow Colorant Particle Dispersion (1) was prepared which contains Minute Colorant Particles (1) at a volume based median diameter of 126 nm.

### Preparation Examples 2-22 Minute Yellow Colorant Particle Dispersion

Minute Yellow Colorant Particle Dispersion 2-22 were prepared in the same manner as Preparation Example 1 of Minute Yellow Colorant Particle Dispersion, except that Pigment Yellow 74 and its amount were replaced with each of pigment species Y1 and its weight, and while C.I. Pigment Yellow 139 and its amount were replaced with each of pigment species Y2 and its weight, as summarized in the following Table A.

TABLE A

| | Yellow Pigment | | | | |
|---|---|---|---|---|---|
| | | | | | Weight |
| | Species | Amount | Species | Amount | Ratio |
| Dispersion | Y1 | (Grams) | Y2 | (Grams) | Y1:Y2 |
| 1 | P.Y. 74 | 22.5 | P.Y. 139 | 2.5 | 90:10 |
| 2 | P.Y. 74 | 17.0 | P.Y. 139 | 8.0 | 68:32 |
| 3 | P.Y. 74 | 15.0 | P.Y. 83 | 10.0 | 60:40 |
| 4 | P.Y. 74 | 20.0 | P.Y. 36 | 5.0 | 80:20 |
| 5 | P.Y. 65 | 23.75 | P.Y. 36 | 1.25 | 95:5 |
| 6 | P.Y. 98 | 22.5 | P.Y. 36 | 2.5 | 90:10 |
| 7 | P.Y. 3 | 22.5 | P.Y. 181 | 2.5 | 90:10 |
| 8 | P.Y. 3 | 17.5 | P.Y. 153 | 7.5 | 70:30 |
| 9 | P.Y. 3 | 23.75 | P.R. 9 | 1.25 | 95:5 |
| 10 | P.Y. 111 | 19.5 | P.Y. 153 | 5.5 | 78:12 |
| 11 | P.Y. 111 | 17.0 | P.Y. 153 | 8.0 | 68:32 |
| 12 | P.Y. 35 | 20.0 | P.Y. 36 | 5.0 | 80:20 |
| 13 | P.Y. 74 | 6.25 | P.Y. 36 | 18.75 | 25:75 |
| 14 | P.Y. 74 | 2.5 | P.Y. 36 | 22.5 | 10:90 |
| 15 | P.Y. 111 | 22.5 | P.Y. 153 | 2.5 | 90:10 |
| 16 | P.Y. 74 | 17.5 | P.Y. 110 | 7.5 | 70:30 |
| 17 | P.Y. 35 | 20.0 | P.Y. 36 | 5.0 | 80:20 |
| 18 | P.Y. 74 | 25.0 | — | 0 | 100:0 |
| 19 | P.Y. 74 | 13.75 | P.Y. 181 | 11.25 | 55:45 |
| 20 | P.Y. 35 | 25.0 | — | 0 | 100:0 |
| 21 | P.Y. 34 | 25.0 | — | 0 | 100:0 |
| 22 | Molybdenum | 25.0 | — | 0 | 100:0 |
| | Orange | | | | |

### Preparation Example of Core Forming Particles 1

### 1) First Stage Polymerization (Formation of Nucleus Particles)

Placed in a 5 L reaction vessel fitted with a stirrer, a thermal sensor, a cooling pipe, and a nitrogen introducing device was a surface active agent solution prepared by dissolving 4 parts by weight of the anionic surface active agent represented by following Formula (P) in 3,040 parts by weight of ion-exchanged water, and while stirring at 230 rpm, the interior temperature was increased to 80° C. under a flow of nitrogen.

Added to the above surface active agent was an initiator solution prepared by dissolving 10 parts by weight of a polymerization initiator (being potassium persulfate, KPS) in 400 parts by weight of ion-exchanged water. After increasing the temperature to 75° C., a monomer mixture solution composed of 523 parts by weight of styrene, 200 parts by weight of n-butyl acrylate, 68 parts by weight of acrylic acid, and 16.4 parts by weight of n-octylmercaptan was dripped over one hour, and polymerization (being first stage polymerization) was performed by heating the resulting mixture at 75° C. over 2 hours, whereby Latex (A1), which was a nucleolus particle dispersion, was prepared. The weight average molecular weight (Mw) of the nucleus particles in resulting Latex (Al) was 16,500.

C₁₀H₂₁(OCH₂CH₂)₂SO₄Na Formula (P):

### 2) Second Stage Polymerization (Formation of Interlayer)

In a flask fitted with a stirrer, 93.3 parts by weight of paraffin wax “HNP-57” (produced by Nippon Seiro Co., Ltd.) were added to a monomer mixture solution composed of 101.1 parts by weight of styrene, 62.2 parts by weight of n-butyl acrylate, 12.3 parts by weight of methacrylic acid, and 1.75 pars by weight of n-octylmercaptan, and were dissolved while heated to 80° C., whereby a monomer solution was prepared.

On the other hand, a surface active agent solution prepared by dissolving 3 parts by weight of the anionic surface active agent, represented by above Formula 1 in 1,560 parts by weight of ion-exchanged water, was heated to 80° C. After adding 32.8 parts by weight, in terms of solids of above Latex (A1), to the resulting surface active agent solution, the above releasing agent monomer solution was added and dispersed over 8 hours, employing mechanical homogenizer “CLEARMIX” (produced by M Technique Co.) having a circulation channel, whereby a dispersion (being an emulsified liquid composition) incorporating emulsified particles (oil droplets) at a dispersion particle diameter of 340 nm was prepared.

Subsequently added to the above dispersion was an initiator solution prepared by dissolving 6 parts by weight of an initiator (KPS) in 200 parts by weight of ion-exchanged water, and the resulting system was heated to 80° C. while stirring over 3 hours to carry out polymerization (being second stage polymerization), whereby Latex (A2) was prepared. The weight average molecular weight (Mw) of Latex (A2) was 23,000.

### 3) Third Stage Polymerization (Formation of Outer Layer)

Added to Resin Particles (A2), prepared as above, was an initiator solution prepared by dissolving 5.45 parts by weight of polymerization initiator (KPS) in 220 parts by weight of ion-exchanged water, and a monomer mixture solution composed of 293.8 parts by weight of styrene, 154.1 parts by weight of n-butyl acrylate, and 7.08 pars by weight of n-octylmercaptan was dripped over one hour. After the above dripping, polymerization (being third stage polymerization) was performed while stirring and heating over two hours. Thereafter, the temperature was lowered to 28° C., whereby Latex (A3) was prepared, which was a dispersion of Core Forming Resin Particles (A) composed of composite resin particles carrying a multilayer structure. Weight average molecular weight (Mw) of resulting Core Forming Resin Particles (A) was 26,800. Further, the weight average diameter of the composite resin particles composing the above Core Forming Resin Particles (A) was 125 nm, while glass transition temperature (Tg) of above Core Forming Resin Particles (A) was 28.1° C.

### Preparation Example of Core Forming Resin Particles 2

### 1) First Polymerization Stage (Formation of Nucleus Particles)

In a 5 L reaction vessel fitted with a stirrer, placed were a thermal sensor, a cooling pipe, and a nitrogen introducing device, 115.9 parts by weight of styrene, 47.7 parts by weight of n-butyl acrylate, 12.3 parts by weight of methacrylic acid, and 93.8 parts by weight of paraffin wax “HNP-57” (produced by Nippon Seiro Co., Ltd.), and were dissolved while heated to 80° C., whereby a polymerizable monomer solution was prepared.

On the other hand, a surface active agent solution was prepared by dissolving 2.9 parts by weight of the anionic surface active agent represented by above Formula Q in 1,340 parts by weight of ion-exchanged water.

After heating the resulting surface active agent solution to 80° C., the above polymerizable monomer solution was mixed and dispersed over two hours, employing mechanical homogenizer “CLEARMIX” (produced by M Technique Co.) having a circulation channel, whereby a dispersion (an emulsified liquid composition) incorporating emulsified particles (oil droplets) at a dispersion particle diameter of 245 nm was prepared.

Subsequently after adding 1,460 parts by weight of ion-exchanged water, the initiator solution, prepared by dissolving 6.1 parts by weight of polymerization initiator (KPS) and 1.8 parts by weight of n-octylmercaptan in 237 parts by weight of ion-exchanged water, was added. After regulating the temperature to 80° C., polymerization (being first stage polymerization) was performed via heating to 80° C. while stirring over three hours, whereby Latex (B1), which was a dispersion of nucleus particles, was prepared. The weight average molecular weight (Mw) of Latex (B1) was 19,600.

### 2) Second Stage Polymerization (Formation of Outer Layer)

Added to Resin Particles (B1), prepared as above, was an initiator solution prepared by dissolving 3.8 parts by weight of polymerization initiator (KPS) in 148 parts by weight of ion-exchanged water, and a monomer mixture solution composed of 300.9 parts by weight of styrene, 146.9 parts by weight of n-butyl acrylate, and 3 parts by weight of methacrylic acid, and 4.93 parts by weight of n-octrlmercaptan was dripped over one hour. After dripping, second stage polymerization (being formation of the outer layer) was performed while stirring and heating over two hours, and the temperature was lowered to 28° C., whereby Latex (B2) was prepared which was a dispersion of Core Forming Resin Particles (B) composed of composite resin particles carrying a multilayer structure. Weight average molecular weight (Mw) of resulting Core Forming Resin Particles (B) was 34,800. Further, the weight average diameter of the composite resin particles composing the above Core Forming Resin Particles (B) was 137 nm, while glass transition temperature (Tg) of above Core Forming Resin Particles (B) was 36° C.

### Preparation Example of Core Forming Resin Particles 3

Core Forming Resin Particles (C) were prepared in the same manner as Preparation Example 2 of Core Forming Resin Particles, except that the polymerizable monomer solution employed in the first stage polymerization (being formation of nucleus particles) was replaced with one composed of 135.9 parts by weight of styrene, 27.4 parts by weight of n-butyl acrylate, and 12.3 pars by weight of methacrylic acid, and the initiator solution was replaced with one prepared by dissolving 6.1 parts by weight of polymerization initiator (KPS) and 0.8 part by weight of n-octylmercaptan in 237 parts by weight of exchanged water. Further, the weight average diameter of the composite resin particles composing above Core Forming Resin Particles (C) was 132 nm, while glass transition temperature (Tg) of above Core Forming Resin Particles (C) was 42.6° C.

### Preparation Example of Comparative Core Forming Particles 1

### 1) First Stage Polymerization (Formation of Nucleus Particles)

Placed in a 5 L separable flask fitted with a stirrer, a thermal sensor, a cooling pipe, and a nitrogen introducing device was a surface active agent solution prepared by dissolving 4 parts by weight of the anionic surface active agent represented by following Formula (Q) in 3,040 parts by weight of Ion-exchanged water, and while stirring at 230 rpm, the interior temperature was increased to 80° C. under a flow of nitrogen.

Added to the above surface active agent was an initiator solution prepared by dissolving 10 parts by weight of polymerization initiator (KPS) in 400 parts by weight of ion-exchanged water. After increasing the temperature to 75° C., a monomer mixture solution, composed of 528 parts by weight of styrene, 204 parts by weight of n-butyl acrylate, 68 parts by weight of methacrylic acid, and 24.4 parts by weight of n-octyl-3-mercaptopropionic acid ester, was dripped over one hour, and polymerization (being first stage polymerization) was performed by heating the resulting system at 75° C. over 2 hours, whereby Latex (D1), which was a nucleolus particle dispersion, was prepared. The weight average molecular weight (Mw) of the nucleus particles in resulting Latex (D1) was 14,000.

C₁₀H₂₁(OCH₂CH₂)₂₀SO₃Na Formula Q:

### 2) Second Stage Polymerization (Formation of Interlayer)

In a flask fitted with a stirrer, 77 parts by weight of the compound represented by following Formula (R), as a releasing agent, were added to a monomer mixture solution composed of 95 parts by weight of styrene, 36 parts by weight of n-butyl acrylate, 9 parts by weight of methacrylic acid, and 0.69 parts by weight of n-octyl-3-mercaptopropionic acid ester, and were dissolved while heated to 90° C., whereby a monomer solution was prepared.

On the other hand, a surface active agent solution prepared by dissolving 1 part by weight of the anionic surface active agent, represented by above Formula 2, in 1,560 parts by weight of ion-exchanged water was heated to 98° C. After adding 28 parts by weight, in terms of solids, of above Latex (D1) to the resulting surface active agent solution, the above monomer solution incorporating the above releasing agents was added and dispersed over 8 hours, employing mechanical homogenizer “CLEARMIX” (produced by M Technique Co.) having a circulation channel, whereby a dispersion. (being an emulsified liquid composition) incorporating emulsified particles (namely oil droplets) at a dispersion particle diameter of 284 nm was prepared.

Subsequently added to the above dispersion (being the emulsified liquid) was an initiator solution prepared by dissolving 5 parts by weight of a polymerization initiator (KPS) in 200 parts by weight of ion-exchanged water, and while stirring, the resulting system was heated to 80° C. over 12 hours to carry out polymerization (second stage polymerization), whereby Latex (D2) was prepared. The weight average molecular weight (Mw) of Latex (D2) was 80,000.

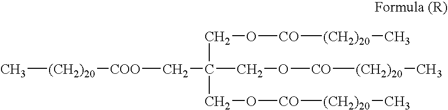

### 3) Formation of Outer Layer (Third Stage Polymerization)

Added to Latex (D2), prepared as above, was an initiator solution prepared by dissolving 6.8 parts by weight of polymerization initiator (KPS) in 265 parts by weight of ion-exchanged water, and a monomer mixture solution, composed of 242.5 parts by weight of styrene, 96.5 parts by weight of n-butyl acrylate, and 18 parts by weight of methacrylic acid, and 8.0 parts by weight of n-octyl-3-mercaptopropionic acid ester, was dripped over one hour. After dripping, polymerization (being third stage polymerization) was performed while stirring and heating over two hours, and the temperature was then lowered to 28° C., whereby Latex (D3) was prepared, which was a dispersion of Comparative Core Forming Resin Particles (D). Weight average molecular weight (Mw) of resulting Core Forming Resin Particles (D) was 37,500. Further, the weight average diameter of the composite resin particles composing the above Core Forming Resin Particles (D) was 128 nm, while glass transition temperature (Tg) of above Core Forming Resin Particles (D) was 52.3° C.

### Preparation Example of Comparative Core Forming Resin Particles 2

Latex (E), which was the dispersion of Comparative Core Forming Resin Particles (E) was prepared in the same manner as Preparation Example 2 of the core forming resin particles, except that the initiator solution employed in the second stage polymerization (formation of the outer layer) was replaced with one which was prepared by dissolving 5.1 parts by weight of the initiator (KPS) in 197 parts by weight of ion-exchanged water, and the monomer solution was replaced with one composed of 193.5 parts by weight of styrene, 220. 5 parts by weight of n-butyl acrylate, 36.0 parts by weight of methacrylic acid, and 5.8 parts by weight of n-octylmercaptan. The weight average molecular weight (Mw) of resulting Core Forming Resin Particles (E) was 42,700. Further, the weight average diameter of the composite resin particles constituting Core Forming Resin Particles (E) was 133 nm, while the glass transition temperature (Tg) of the resulting Core Forming Resin Particles (E) was 9.2° C.

### Preparation Example of Shell Forming Resin Particles 1

The latex of Shell Forming Resin Particles (F) was prepared in the same manner as Preparation Example 1 of Core Forming Resin Particles, except that the monomer mixture solution employed in the first stage polymerization (formation of nucleus particles) was replaced with one composed of 624 parts by weight of styrene, 120 parts by weight of 2-ethylhexyl acrylate, 56 parts by weight of methacrylic acid, and 16.4 parts by weight of n-octylmercaptan. The weight average molecular weight (Mw) of resulting Shell Forming Resin Particles (F) was 16,400. Further, the weight average diameter of the composite resin particles constituting Shell Forming Resin Particles (F) was 95 nm, while the glass transition temperature (Tg) of the resulting Shell Forming Resin Particles (F) was 62.6° C.

### Preparation Example of Yellow Toner Particles 1

### 1) Formation of Core Particles

While stirring, placed in a reaction vessel fitted with a thermal sensor, a cooling pipe, a nitrogen introducing device, and a stirrer were 420.7 parts by weight in terms of solids of Latex (A3) of above Core Forming Resin Particles (A) and 200 parts by weight of Yellow Colorant Particle Dispersion (1). After regulating the temperature in the vessel to 30° C., the pH was controlled within 8-11 by the addition of a 5 mol/L aqueous sodium hydroxide solution.

Subsequently, while stirring, an aqueous solution prepared by dissolving 2 parts by weight of magnesium chloride hexahydrate in 1,000 parts by weight of ion-exchanged water was added at 30° C. over 10 minutes. After being allowed to stand for three minutes, the temperature was increased to 65° C. over 60 minutes. In such a state, the particle diameter of coalesced particles was determined employing “COULTER COUNTER TA-II” (produced by Beckmann Coulter Co.). When the volume based median diameter reached 5.5 μm, the diameter increase was terminated by the addition of an aqueous solution prepared by dissolving 40.2 parts by weight of sodium chloride in 1,000 parts by weight of ion-exchanged water. Further, while stirring, ripening was performed at a liquid temperature of 70° C. for one hour so that fusion continued, whereby Core Particles (1) were formed.

Degree of circularity of the resulting Core Particles (1) was determined via “FPIA2000” (produced by SYSTEX Co., Ltd.), resulting in an average of 0.912.

### 2) Formation of Shell Layer

Subsequently, 96 parts by weight of the latex of Shell Forming Rein Particles (F) were added at 65° C. After adding an aqueous solution prepared by dissolving 2 parts by weight of magnesium chloride hexahydrate in 1,000 parts by weight of ion-exchanged water, the temperature was increased to 70° C. (being shell forming temperature) and stirring was continued over one hour. After fusing Shell Forming Resin Particles (F) onto the surface of Core Particles (1), the shell layer was completed via ripening at 75° C. for 20 minutes.

Subsequently, 40.2 parts by weight of sodium chloride were added and the temperature was lowered to 30° C. at a rate of 6° C./minute. The resulting fused particles were collected via filtration and repeatedly washed with ion-exchanged water at 45° C. Thereafter, drying was carried out employing 40° C. air flow, whereby Yellow Toner (1) was prepared in which a shell layer was formed on the surface of the core particles. Table 1 describes the types and ratios of yellow pigments employed in above Yellow Toner 1.

### Preparation Examples of Yellow Toners 2-17 and Preparation Examples of Comparative Yellow Toners 18-22

Yellow Toners 2-17 and Comparative Yellow Toners 19-22 were prepared in the same manner as Preparation Example 1 of Yellow Toner, except that each of Core Forming Resin Particles (A) and Minute Yellow Colorant Particle Dispersion were replaced with each of those described in following Tables 1-1. and 1-2. The types and ratio of yellow pigments employed in above Yellow Toners 2-17 and Comparative Yellow Toners 18-22 are shown in Tables 1-1 and 1-2.

TABLE 1-1

| | Yellow Pigment | | | | | | |
|---|---|---|---|---|---|---|---|
| | Species (*) | | Weight Ratio | Reflectance | | | |
| Toner No. | Y1 | Y2 | of Y1:Y2 | A₄₁₅ + A₄₆₀ | A₅₁₀ − A₄₉₀ | A₅₅₀ − A₅₃₀ | A₅₅₀ |
| Yellow Toner 1 | P.Y. 74 | P.Y. 139 | 90:10 | 14 | 30 | 5 | 80 |
| Yellow Toner 2 | P.Y. 74 | P.Y. 139 | 68:32 | 12 | 28 | 14 | 82 |
| Yellow Toner 3 | P.Y. 74 | P.Y. 83 | 60:40 | 12 | 28 | 3 | 83 |
| Yellow Toner 4 | P.Y. 74 | P.Y. 36 | 80:20 | 24 | 30 | 16 | 82 |
| Yellow Toner 5 | P.Y. 65 | P.Y. 36 | 95:5 | 24 | 30 | 2 | 81 |
| Yellow Toner 6 | P.Y. 98 | P.Y. 36 | 90:10 | 24 | 30 | 8 | 76 |
| Yellow Toner 7 | P.Y. 3 | P.Y. 181 | 90:10 | 3 | 30 | 10 | 78 |
| Yellow Toner 8 | P.Y. 3 | P.Y. 153 | 70:30 | 3 | 30 | 16 | 77 |
| Yellow Toner 9 | P.Y. 3 | P.R. 9 | 95:5 | 3 | 20 | 4 | 80 |
| Yellow Toner 10 | P.Y. 111 | P.Y. 153 | 78:12 | 13 | 37 | 15 | 76 |
| Yellow Toner 11 | P.Y. 111 | P.Y. 153 | 68:32 | 13 | 37 | 15 | 75 |
| Yellow Toner 12 | P.Y. 35 | P.Y. 36 | 80:20 | 24 | 40 | 2 | 74 |
| Yellow Toner 13 | P.Y. 74 | P.Y. 36 | 25:75 | 24 | 20 | 9 | 77 |
| Yellow Toner 14 | P.Y. 74 | P.Y. 36 | 10:90 | 24 | 20 | 16 | 78 |
| Yellow Toner 15 | P.Y. 111 | P.Y. 153 | 90:10 | 13 | 37 | 9 | 76 |
| Yellow Toner 16 | P.Y. 74 | P.Y. 110 | 70:30 | 26 | 22 | 3 | 80 |
| Yellow Toner 17 | P.Y. 35 | P.Y. 36 | 80:20 | 24 | 40 | 2 | 74 |
| Yellow Toner 18 | P.Y. 74 | — | 100:0 | 2 | 45 | 3 | 79 |
| Yellow Toner 19 | P.Y. 74 | P.Y. 181 | 55:45 | — | 18 | — | 82 |
| Yellow Toner 20 | P.Y. 35 | — | 100:0 | 15 | 17 | 5 | 81 |
| Yellow Toner 21 | P.Y. 34 | — | 100:0 | 3 | 12 | 13 | 82 |

| | | | | | | |
|---|---|---|---|---|---|---|
| Yellow Toner 22 | Molybdenum Orange | 100:0 | 5 | 5 | 4 | 88 |

(*) P.Y.: Pigment Yellow

TABLE 1-2

| | Core | | | |
|---|---|---|---|---|
| | Forming | | | |
| | Resin | Toner | Molecular | |
| Toner No. | Particles | Tg (° C.) | weight peak | S.P. (° C.) |
| Yellow Toner 1 | A | 28.1 | 10,600 | 88 |
| Yellow Toner 2 | A | 28.1 | 10,600 | 88 |
| Yellow Toner 3 | A | 28.1 | 10,600 | 88 |
| Yellow Toner 4 | A | 28.1 | 10,600 | 88 |
| Yellow Toner 5 | A | 28.1 | 10,600 | 88 |
| Yellow Toner 6 | B | 36.0 | 15,400 | 99 |
| Yellow Toner 7 | C | 42.6 | 14,200 | 112 |
| Yellow Toner 8 | B | 36.0 | 15,400 | 99 |
| Yellow Toner 9 | C | 42.6 | 14,000 | 112 |
| Yellow Toner 10 | A | 28.1 | 10,600 | 88 |
| Yellow Toner 11 | A | 28.1 | 10,600 | 88 |
| Yellow Toner 12 | A | 28.1 | 10,600 | 88 |
| Yellow Toner 13 | A | 28.1 | 10,600 | 88 |
| Yellow Toner 14 | A | 28.1 | 10,600 | 88 |
| Yellow Toner 15 | A | 28.1 | 10,600 | 88 |
| Yellow Toner 16 | D | 52.8 | 16,000 | 88 |
| Yellow Toner 17 | E | 9.2 | 20,100 | 114 |
| Yellow Toner 18 | A | 28.1 | 10,600 | 74 |
| Yellow Toner 19 | A | 28.1 | 10,600 | 88 |
| Yellow Toner 20 | A | 28.1 | 10,600 | 88 |
| Yellow Toner 21 | A | 28.1 | 10,600 | 88 |
| Yellow Toner 22 | A | 28.1 | 10,600 | 88 |

### Preparation Example of Minute Magenta Colorant Dispersion 1

While stirring, 11.5 parts by weight of sodium n-dodecylsulfate were dissolved in 160 parts by weight of ion-exchanged water followed by the gradual addition of each of 22.5 parts by weight of Exemplified Dye 1 (species M1) and 2.5 parts by weight of Exemplified Dye 4 (species M2). Subsequently, the resulting mixture was dispersed employing “CLEARMIX W MOTION CLM-0.8” (produced by M Technique Co.), and Minute Colorant Particle Dispersion 1 was prepared.

### Preparation Example of Minute Magenta Colorant Dispersions 2-5

Minute Magenta Colorant Particle Dispersion 2-5 were prepared in the same manner as Example of Minute Magenta. Colorant Dispersion 1, except that Dye 1 (species M1) and its amount were replaced with each of pigment species M1 and its weight, and while Dye 4 (species M2) and its amount were replaced with each of pigment species M2 and its weight, as summarized in the following Table 2-1.

### (Preparation Examples of Magenta Toners 1-5

Magenta Toners 1-5 were prepared in the same manner as Preparation Example 1 of Yellow Toner, except that Minute Magenta Colorant Particle Dispersion were replaced with the same amount of each of Minute Magenta Colorant Particles described in following Table 2-2.

TABLE 2-1

| | Pigment | | | | | | |
|---|---|---|---|---|---|---|---|
| | | | Weight | | | | |
| Toner | Species (*) | | Ratio of | Reflectance | | | |
| No. | M1 | M2 | M1:M2 | B₄₅₀ − B₅₂₀ | B₅₃₀ + B₅₇₀ | B₆₇₀ − B₆₀₀ | B₆₇₀ |
| Magenta | Dye-1 | Dye-5 | 90:10 | 55 | 18 | 34 | 90 |
| Toner 1 | | | | | | | |
| Magenta | Dye-2 | P.R. 9 | 95:5 | 50 | 15 | 49 | 90 |
| Toner 2 | | | | | | | |
| Magenta | Dye-2 | P.R. 9 | 50:50 | 33 | 7 | 25 | 90 |
| Toner 3 | | | | | | | |
| Magenta | Dye-3 | P.R. 9 | 82:18 | 48 | 6 | 9 | 90 |
| Toner 4 | | | | | | | |
| Magenta | Dye-4 | P.R. 9 | 50:50 | 80 | 6 | 5 | 90 |
| Toner 5 | | | | | | | |

(*) P.R.: Pigment Red

TABLES 2-2

| | Core | | | |
|---|---|---|---|---|
| | Forming | | | |
| | Resin | Toner | Molecular | |
| Toner No. | Particles | Tg (° C.) | peak | S.P. (° C.) |
| Magenta Toner 1 | A | 28.1 | 10,600 | 88 |
| Magenta Toner 2 | A | 28.1 | 10,600 | 88 |
| Magenta Toner 3 | A | 28.1 | 10,600 | 88 |
| Magenta Toner 4 | A | 28.1 | 10,600 | 88 |
| Magenta Toner 5 | A | 28.1 | 10,600 | 88 |

### Preparation Example of Minute Cyan Colorant Dispersion 1

While stirring, 11.5 parts by weight of sodium n-dodecylsulfate were dissolved in 160 parts by weight of ion-exchanged water followed by the gradual addition of each of 20.0 parts by weight of C.I. Pigment Blue 15:3. Subsequently, the resulting mixture was dispersed employing “CLEARMIX W MOTION CLM-0.8” (produced by M Technique Co.).

### Preparation Examples of Cyan Toner 1

Cyan Toner 1 was prepared in the same manner as Preparation Example 1 of Yellow Toner, except that Minute Magenta Colorant Particle Dispersion was replaced with Minute Cyan Colorant Dispersion 1.

### (Preparation of Developer)

Each of above Yellow Toners 1-15 and Comparative Yellow Toners 16-22, magenta toners 1-4 and cyan toner 1 was blended with a silicone resin-coated ferrite carrier at a volume average particle diameter of 50 μm so that the above toner concentration reached 6% by weight, whereby each of developers, all of two-component developers, were prepared.

### Examples 1-21 and Comparative Examples 1-5

Each of above Yellow Developers, magenta developers and cyan developer in combination listed Table 3 was loaded in a commercial composite machine “SITIOS 9331” (produced by Konica Minolta Business Technologies, Inc.) in which the external diameter of the development roller was modified to 9 mm, and image formation was carried out at a linear rate of 280 mm/minute (being approximately 50 sheets/minute). Subsequently, the resulting prints were subjected to following evaluations (1)-(3), in which evaluation criteria “A” and “B” refer to commercial viability, while “C” and “D” refer to commercial non-viability.

### (1) Color Evaluation of Red Logos

Each of the logos of 50 companies, which employed red in their logos, was displayed on the computer display, detailed below, and was printed on “WASHI COPY DAIO”, transfer paper (produced by OZU Corp.). Evaluation was carried out based on the number out of 100 randomly selected panelists aged between teens-seventies, who evaluated that the color of the logos on the transfer sheet was reproduced without any uncomfortable feeling.

### (Evaluation Criteria)

A: at least 90 panelists evaluated the color as “reproduced” (excellent)
B: at least 80-less than 90 panelists evaluated the color as “reproduced” (good)
C: at least 60-less than 80 panelists evaluated the color as “reproduced” was (commercially viable)
D: less than 60 panelists evaluated the color as “reproduced” was (poor)

### (Computer)

iMac (Apple Computer Co., Ltd.), 24-inch wide screen LCD, resolution 1,920×1,200 pixels, 2.16 GHz Intel Core 2 Duo processor 1, 4 MB shared L2 cache, 1 GB memory (2×512 MB SO-DIMM), 250 GB serial ATA hard drive 2, 8× double layer system Super Drive (DVD+R DL, DVD±RW, CD-RW), NVIDIA CeForce 7300 GT 128 MB GDDR3 memory, Air Mac Extreme, and built-in Bluetooth 2, and Apple Remote

### (2) Evaluation of Color Reproduction of Mandarin Orange and Citrus Family

A total of ten citrus fruits consisting of two each of mandarin oranges (or mandarins),
unshu mikan (botanical name: citrus unshu Mar.),
grape fruit (botanical name: citrus X paradise),
hon yuzu (Latin name: yuzu, and botanical name: citrus junos), and
lemon (botanical name: citrus limon)
   were photographed under sunlight, and the resulting images were displayed on the above computer display, and were then printed onto “POD GLOSS COAT 80 g/m²”, transfer paper (produced by Oji Paper Co., Ltd.). In the same manner as above, the number of panelists among 100, who evaluated that the color of the image on the display was reproduced on the transfer sheet without any uncomfortable feeling, was determined, and evaluation was carried out based on the following criteria.

### (Evaluation Criteria)

A: at least 80 panelists evaluated the color as “reproduced” (excellent)
B: at least 65-less than 80 panelists evaluated the color as “reproduced” (good)
C: at least 50-less than 65 panelists evaluated the color as “reproduced” (commercially viable)
D: less than 50 panelists evaluated the color as “reproduced” (poor)

### (3) Evaluation of Damaged Characters

By employing a commercial word processor software (MICROSOFT WORD 2003), Japanese characters in columns of Japanese newspaper were transferred on a text box filled with yellow, and were printed onto “WASHI COPY DAIO”, transfer paper (produced by OZU Corp.) to realize 3-point size characters. The resulting images were visually evaluated based on the following criteria.

### (Evaluation Criteria)

A: excellent, resulting in neither damaged Japanese characters nor smearing
B: readable except for some complicated Japanese characters
C: difficult to read and high occurrence of unreadable Japanese characters

TABLE 3-1

| | Toner | | | Evaluation Result | | | Lowest |
|---|---|---|---|---|---|---|---|
| | Yellow | Magenta | Cyan | | Photograph | | Fixing |
| | Toner | Toner | Toner | Red | of Citrus | Damaged | Temp |
| | No. | No. | No. | Logo | Family | Characters | (° C.) |
| Example 1 | 1 | 1 | 1 | A | A | A | 105 |
| Example 2 | 2 | 1 | 1 | A | B | A | 105 |
| Example 3 | 3 | 1 | 1 | A | B | A | 105 |
| Example 4 | 4 | 1 | 1 | A | B | A | 105 |
| Example 5 | 5 | 1 | 1 | A | B | A | 105 |
| Example 6 | 6 | 1 | 1 | A | B | A | 115 |
| Example 7 | 7 | 1 | 1 | A | B | A | 160 |
| Example 8 | 8 | 1 | 1 | A | B | A | 115 |
| Example 9 | 9 | 1 | 1 | A | B | A | 160 |
| Example 10 | 10 | 2 | 1 | B | B | A | 105 |
| Example 11 | 11 | 2 | 1 | B | B | A | 105 |
| Example 12 | 12 | 2 | 1 | B | B | A | 105 |
| Example 13 | 13 | 3 | 1 | B | B | A | 105 |
| Example 14 | 14 | 3 | 1 | B | B | A | 105 |
| Example 15 | 15 | 3 | 1 | B | B | A | 105 |
| Example 16 | 1 | 2 | 1 | A | A | B | 190 |
| Example 17 | 1 | 3 | 1 | A | A | A | 105 |
| Example 18 | 1 | 4 | 1 | A | A | A | 105 |
| Example 19 | 1 | 5 | 1 | A | A | A | 105 |
| Example 20 | 16 | 1 | 1 | B | B | B | 190 |
| Example 21 | 17 | 1 | 1 | B | B | B | 90 |
| Comparative | 18 | 1 | 1 | E | D | B | 105 |
| Example 1 | | | | | | | |
| Comparative | 19 | 1 | 1 | D | E | B | 105 |
| Example 2 | | | | | | | |
| Comparative | 20 | 1 | 1 | D | E | B | 105 |
| Example 3 | | | | | | | |
| Comparative | 21 | 1 | 1 | D | E | B | 105 |
| Example 4 | | | | | | | |
| Comparative | 22 | 1 | 1 | D | E | B | 105 |
| Example 5 | | | | | | | |

As described above, it was confirmed that by employing Yellow Toners 1-17 according to the present invention, it was possible to realize excellent reproduction of red which was a secondary color formed via combination of magenta toners and to also realize an extremely wide color gamut of red.

1. An image forming method comprising steps of,
forming latent images corresponding to yellow, magenta and cyan images on a photoreceptor or photoreceptors,
developing the latent images by developers containing yellow, magenta and cyan toner corresponding to the latent images to form yellow, magenta and cyan images and
transferring the yellow, magenta and cyan images on a recording material,
wherein the yellow toner has reflectance characteristics of
2≦A₄₁₅+A₄₆₀≦24,
20≦A₅₁₀−A₄₉₀≦40,
2≦A₅₅₀−A₅₃₀≦16,
70≦A₅₅₀,
and the magenta toner has reflectance characteristics of
30≦B₄₅₀−B₅₂₀≦85,
1≦B₅₃₀+B₅₇₀≦25,
2≦B₆₇₀−B₆₀₀≦50, and
80≦B₆₇₀,
wherein A₄₁₅, A₄₆₀, A₄₉₀, A₅₁₀, A₅₃₀, and A₅₅₀, each are reflectance in percent at a wavelength of 415 nm, 460 nm, 490 nm, 510 nm, 530 nm, and 550 nm in a reflectance spectrum of an image formed by the yellow toner, respectively, and
B₄₅₀, B₅₂₀, B₅₃₀, B₅₇₀, B₆₀₀, and B₆₇₀ a each are reflectance in percent at a wavelength of 450 nm, 520 nm, 530 nm, 570 nm, 600 nm, and 670 nm of an image formed by the magenta toner, respectively.

2. The image forming method of claim 1, wherein reflectance A₄₁₅ at a wavelength of 415 nm is in the range of 7-12%, reflectance A₅₇₀ at a wavelength of 570 nm is in the range of 75-85%, reflectance A₇₀₀ at a wavelength of 700 nm is in the range of 85-95%.

3. The image forming method of claim 1, wherein the yellow toner contains a pigment selected from the group consisting of Pigment Yellow 3, Pigment Yellow 34, Pigment Yellow 35, Pigment Yellow 65, Pigment Yellow 74, Pigment Yellow 98, and Pigment Yellow 111.

4. The image forming method of claim 1, wherein the yellow toner contains pigments selected from at least Groups Y1 and Y2 at a respective weight ratio of 65:35-95:5;
(Group Y1): Pigment Yellow 3, Pigment Yellow 34, Pigment Yellow 35, Pigment Yellow 65, Pigment Yellow 74, Pigment Yellow 98, and Pigment Yellow 111,
(Group Y2): Pigment Yellow 36, Pigment Yellow 83, Pigment Yellow 110, Pigment Yellow 139, Pigment Yellow 181, Pigment Yellow 153, and Pigment Red 9.

5. The image forming method of claim 4, wherein the yellow pigments of are selected from at least Groups Y11 and Y21;
(Group Y1): Pigment Yellow 65, Pigment Yellow 74, Pigment Yellow 98, and Pigment Yellow 111,
(Group Y21): Pigment Yellow 83, Pigment Yellow 139, Pigment Yellow 181, and Pigment Yellow 153.

6. The image forming method of claim 1, wherein the yellow toner contains a pigment having been subjected to surface modification.

7. The image forming method of claim 6, wherein the yellow pigment has been subjected to surface modification by silane coupling agent, titanium coupling agent, aluminum coupling agent or rosin.

8. The image forming method of claim 1, wherein the magenta toner comprises an oil soluble dye or a chelate dye.

9. The image forming method of claim 9, wherein the chelate dye is represented by a formula of
(Dye)ₙM (A)ₘ
wherein M is a metal ion, “Dye” is a dye capable of coordinating to the metal ion, A represents a ligand other than the dye, n is an integer of 1 to 3, and m is an integer of 0 and 1 to 3, provided that when m is 0, n is 2 or 3 and plural “Dye”s may be the same or different.

10. The image forming method of claim 1, wherein the toner has softening point temperature of 75-112° C.

11. A yellow toner comprising a colorant and a binder resin wherein reflectance of the toner has characteristics of
2≦A₄₁₅+A₄₆₀≦24,
20≦A₅₁₀−A₄₉₀≦40,
2≦A₅₅₀−A₅₃₀≦16,
70≦A₅₅₀,
wherein A₄₁₅, A₄₆₀, A₄₉₀, A₅₁₀, A₅₃₀,and A₅₅₀, each are reflectance in percent at a wavelength of 415 nm, 460 nm, 490 nm, 510 nm, 530 nm, and 550 nm in a reflectance spectrum of an image formed by the yellow toner, respectively.

12. The yellow toner of claim 11, wherein reflectance A₄₁₅ at a wavelength of 415 nm is in the range of 7-12%, reflectance A₅₇₀ at a wavelength of 570 nm is in the range of 75-85%, reflectance A₇₀₀ at a wavelength of 700 nm is in the range of 85-95%.

13. The yellow toner of claim 11, which contains a pigment selected from the group consisting of Pigment Yellow 3, Pigment Yellow 34, Pigment Yellow 35, Pigment Yellow 65, Pigment Yellow 74, Pigment Yellow 98, and Pigment Yellow 111.

14. The yellow toner of claim 11, which contains pigments selected from at least Groups Y1 and Y2 at a respective weight ratio of 65:35-95:5;
(Group Y1): Pigment Yellow 3, Pigment Yellow 34, Pigment Yellow 35, Pigment Yellow 65, Pigment Yellow 74, Pigment Yellow 98, and Pigment Yellow 111,
(Group Y2): Pigment Yellow 36, Pigment Yellow 83, Pigment Yellow 110, Pigment Yellow 139, Pigment Yellow 181, Pigment Yellow 153, and Pigment Red 9.

15. The yellow toner of claim 14, wherein the yellow pigments of are selected from at least Groups Y11 and Y21;
(Group Y11) Pigment Yellow 65, Pigment Yellow 74, Pigment Yellow 98, and Pigment Yellow 111,
(Group Y21) Pigment Yellow 83, Pigment Yellow 139, Pigment Yellow 181, and Pigment Yellow 153.

16. The yellow toner of claim 11, which contains a pigment having been subjected to surface modification.

17. The yellow toner of claim 16, wherein the yellow pigment has been subjected to surface modification by silane coupling agent, titanium coupling agent, aluminum coupling agent or rosin.
